(19) United States
(12) Patent Application Publication
(10) Pub. No.: US 2006/0112092 A1
(43) Pub. Date: May 25, 2006

(54) Content-based image retrieval method

(75) Inventors: Djemel Ziou, Quebec (CA); Mohammed Lamine Kherfi, Quebec (CA); Alan Bernardi, Quebec (CA)

Correspondence Address: VENABLE LLP, P.O. BOX 34385, WASHINGTON, DC, 20045-9998, US

(73) Assignee: BELL CANADA, Quebec (CA)

(21) Appl. No.: 10/523,798

(22) PCT Filed: Aug. 11, 2003
(86) PCT No.: PCT/CA03/01215

§ 371 Date: Oct. 26, 2005

(30) Foreign Application Priority Data
Aug. 9, 2002 (CA) 2397424

(51) Int. Cl. G06F 17/30

(52) U.S. Cl. 707/5

(57) ABSTRACT

Although negative example can be highly useful to better understand the user's needs in content-based image retrieval, it was considered by few authors. A content-based image retrieval method according to the present invention addresses some issues related to the combination of positive and negative examples to perform a more efficient image retrieval. A relevance feedback approach that uses positive example to perform generalization and negative example to perform specialization is described herein. In this approach, a query containing both positive and negative example is processed in two general steps. The first general step considers positive example only in order to reduce the set of images participating in retrieval to a more homogeneous subset. Then, the second general step considers both positive and negative examples and acts on the images retained in the first step. Mathematically, relevance feedback is formulated as an optimization of intra and inter variances of positive and negative examples.

### FIELD OF THE INVENTION

The present invention relates to digital data retrieval. More specifically, the present invention is concerned with content-based image retrieval.

### BACKGROUND OF THE INVENTION

With advances in the computer technologies and the advent of the World-Wide Web, there has been an explosion in the quantity and complexity of digital data being generated, stored, transmitted, analyzed, and accessed. These data take different forms such as text, sound, images and videos.

For example, the increasing number of digital images available brings the need to develop systems for efficient image retrieval which can help users locate the needed images in a reasonable time. Some of these retrieval systems use attributes of the images, such as the presence of a particular combination of colors or the depiction of a particular type of event. Such attributes may either be derived from the content of the image or from its surrounding text and data. This leads to various approaches in image retrieval such as content-based techniques and text-based techniques.

In any case, when an image retrieval system returns the results of a given query, two problems often arise: noise and miss. Noise arises when images which don't correspond to what the user wants are retrieved by the system. Miss is the set of images corresponding to what the user wants which have not been retrieved. These two problems originate from imperfections at different levels. Indeed, it may not be easy for the user to formulate an adequate query using the available images, either because none of them correspond to what the user wants or because the user lacks sufficient knowledge of imagery details to articulate image features. Also, it has been found difficult to translate the user's needs and specificities in terms of image features and similarity measures.

More specifically in the case of content-based image retrieval, one can distinguish many ways of formulating queries. Early systems such as QBIC, which is described by Flicker et al. in “Query by image and video content. The QBIC system” in IEEE Computer Magazine, 28:23-32, 1995, prompt the user to select image features such as color, shape, or texture. Other systems like BLOBWORLD which is described by Carson et al. in “A system for region-based image indexing and retrieval” from the International Conference on Visual Information Systems, pages 509-516, Amsterdam, 1999, require the user to provide a weighted combination of features.

However, a drawback of such content-based image retrieval techniques is that it is generally difficult to directly specify the features needed for a particular query, for several reasons. A first of such reasons is that not all users understand the image vocabulary (e.g. contrast, texture, color) needed to formulate a given query. A second reason is that, even if the user is an image specialist, it is not easy to translate the images the user has in mind into a combination of features.

An alternative approach is to allow the user to specify the features and their corresponding weights implicitly via a visual interface known in the art as “query by example”. Via this process, the user can choose images that will participate in the query and weight them according to their resemblance to the images sought. The results of the query can then be refined repeatedly by specifying more relevant images. This process, referred to in the art as “relevance feedback” (RF), is defined Rui et al. in “Content-based image retrieval with relevance feedback in MARS” from the IEEE International Conference on Image Processing, pages 815-818, Santa Barbara, Calif., 1997, as the process of automatically adjusting an existing query using information fed back by the user about the relevance of previously retrieved documents.

Relevance feedback is used to model the user subjectivity in several stages. First, it can be applied to identify the ideal images that are in the user's mind. At each step of the retrieval, the user is asked to select a set of images which will participate in the query; and to assign a degree of relevance to each of them. This information can be used in many ways in order to define an analytical form representing the query intended by the user. The ideal query can then be defined independently from previous queries, as disclosed in “Mindreader: Query databases through multiple examples” in 24th International Conference on Very Large Data Bases, pages 433-438, New York, 1998 by Ishikawa et al. It can also depend on the previous queries, as in the “query point movement method” where the ideal query point is moved towards positive example and away from negative example. This last method is explained by Zhang et al. in “Relevance Feedback in Content-Based Image Search” from the 12th International Conference on New Information Technology (NIT) in Beijing, May 2001.

Relevance feedback allows also to better capture the user's needs by assigning a degree of importance (e.g. weight) to each feature or by transforming the original feature space into a new one that best corresponds to the user's needs and specificities. This is achieved by enhancing the importance of those features that help in retrieving relevant images and reducing the importance of those which do not. Once the importance of each feature is determined, the results are applied to define similarity measures which correspond better to the similarity intended by the user in specific current query.

The operation of attributing weights to features can also be applied to perform feature selection, which is defined by Kim et al. in “Feature Selection in Unsupervised Learning via Evolutionary Search” from the 6th ACM SIGKDD International Conference on Knowledge Discovery and Data Mining (KDD-00), pages 365-369, San Diego, 2000, as the process of choosing a subset of features by eliminating redundant features or those providing little or no predictive information. In fact, after the importance of each feature is determined, feature selection can be performed by retaining only those features which are important enough; the rest being eliminated. By eliminating some features, retrieval performance can be improved because, in a low-dimension feature space, it is easier to define good similarity measures, to perform retrieval in a reasonable time, and to apply effective indexing techniques (for more detail, see “Web Image Search Engines: A Survey. Technical Report N° 276, Université de Sherbrooke, Canada, December 2001, by Kherfi et al.).

Relevance feedback using positive examples is very well known in the art. For example, Ishikawa et al. define a quadratic distance function for comparing images. Considering a query consisting of N images, each image represented by an I-dimension feature vector \vec{x}ₙ=[xₙ₁, . . . , xₙ₁]^{T}, where T denotes matrix transposition and considering also that the user associates each image participating in the query with a degree of relevance πₙ which represents its degree of resemblance with the sought images Ishikawa et al. compute two parameters, namely the ideal query \vec{q}=[q₁, . . . , q₁]^{T} and the ellipsoid distance matrix W, that minimize the quantity D given in Equation (1), which represents the global distance between the query images and the ideal query:

$$D = {\sum }_{n = 1}^{N} {{π}_{n} ( {\vec{x}}_{n} - \vec{q} )}^{T} W ( {\vec{x}}_{n} - \vec{q} ) \qquad ( 1 )$$

A drawback of the method proposed, by Ishikawa et al. is that it doesn't support the negative example.

Rui et al.(2) in “Optimizing Learning in Image Retrieval”. IEEE international Conference On Computer Vision and Pattern Recognition, Hilton Head, S.C., USA, 2000 disclose a method where each image is decomposed into a set of I features, each of which represented by a vector of reals. \vec{x}ₙᵢ represents the i^{th} feature vector of the n^{th} query image and πₙ the degree of relevance assigned by the user to the n^{th} image. It is assumed also that the query consists of N images. For each feature i, the ideal query vector \vec{q}ᵢ, a matrix Wᵢ and scalar weight uᵢ which minimize the global dispersion of the query images given by Equation (2) are computed. Minimizing the dispersion of the query images aims at enhancing the concentrated features, i.e., features for which example images are close to each other.

$$J = {\sum }_{i = 1}^{I} {u}_{i} {\sum }_{n = 1}^{N} {{π}_{n} ( {\vec{x}}_{ni} - {\vec{q}}_{qi} )}^{T} {W}_{i} ( {\vec{x}}_{ni} - {\vec{q}}_{i} ) \qquad ( 2 )$$

In “Efficient Indexing, Browsing and Retrieval of lmage/Video Content”, PhD thesis, Department of Computer Science, University of Illinois at Urbana-Champaign, 1999, Rui et al (3) propose to use a similar model but with negative degrees of relevance assigned to negative example images. A drawback of this model, is that it leads to neglect the relevant features of negative example, so that negative example will be confused with positive example.

It is to be noted that, while many studies have focused on how to learn from user interaction in relevance feedback, few of them evoked the relevance of negative example. However, negative example can be useful for query refinement since it allows to determine the images the user doesn't want in order to discard them. Indeed, Müller et al. shows, in “Strategies for Positive and Negative Relevance Feedback in Image Retrieval.”, Technical Report N° 00.01, Computer Vision Group, Computing Center, University of Geneva, 2000, that, using only positive feedback, yields major improvement only at the first feedback step, while improvement is remarkable for the four first steps with positive and negative feedback where the results continuously get better.

Relevance feedback with negative example may also be useful to reduce noise (undesired images that have been retrieved) and to decrease the miss (desired images that have not been retrieved). Indeed, after the results of a given query are obtained, the user can maintain the positive example images and enrich the query by including some undesired images as negative example. This implies that images similar to those of negative example will be discarded, thus reducing noise. At the same time, the discarded images will be replaced by others which would have to resemble better what the user wants. Hence, the miss will also be decreased. Furthermore, the user can find, among the recently retrieved images, more images that resemble what the user needs and use them to formulate a new query. Thus, the use of negative example would help to resolve what is called the page zero problem, i.e., that of finding a good query image to initiate retrieval. By mitigating the page zero problem, it has been found that the retrieval time is reduced and the accuracy of the results is improved (see Kherfi et al). It is also to be noted that relevance feedback with negative example is useful when, in response to a user feed-back query, the system returns exactly the same images as in a previous iteration. Assuming that the user has already given the system all the possible positive feedback, the only way to escape from this situation is to choose some images as negative feedback.

Consider the interpretation of results for content-based image retrieval methods involving negative example, one can distinguish two categories of models. In the first category, the positive example images are selected by the user; however, the negative example images are chosen automatically by the retrieval system among those not selected by the user. In the second category, both positive and negative example images are chosen by the user.

Müller et al. describe a content-based image retrieval method from the first category. Concerning the initial query, they propose to enrich it by automatically supplying non-selected images as negative example. For refinement, the top 20 images resulting from the previous query as positive feedback are selected. As negative feedback, four of the non-returned images are chosen. The Müller method allows refinement through several feedback steps; each step aims at moving the ideal query towards the positive example and away from the negative example. More specifically, this is achieved by using the following formula proposed by Rocchio in “Relevance Feedback in Information Retrieval” in SMART Retrieval System, Experiments in Automatic Document Processing, pages 323-323, New Jersey, 1971:

$$Q = \frac{α}{{n}_{1}} {\sum }_{i = 1}^{{n}_{1}} {R}_{i} - \frac{β}{{n}_{2}} {\sum }_{i = 1}^{{n}_{2}} {S}_{i} \qquad ( 3 )$$

where Q is the ideal query, n₁ and n₂ are the numbers of positive and negative images in the query respectively, and Rᵢ and Sᵢ are the features of the positive and negative images respectively. α and β determine the relative weighting of the positive and negative examples. The values α=0.65 and β=0.35, which are used for some text-retrieval systems are used (see Müller et al).

Since the system selects negative example images automatically, a drawback of systems from the first category, is that using inappropriate images can destroy the query. Indeed, if the system chooses as negative example some images which should rather be considered as positive example, then the relevant features of these images will be discarded, and this will mislead the retrieval process.

Vasconcelos et al. in “Learning from User Feedback in Image Retrieval Systems.” in Neural Information Processing Systems 12, Denver, Colo., 1999 disclose a content-based image retrieval methods involving negative example from the second category. More specifically, they propose a Bayesian model for image retrieval, operating on the assumption that the database is constituted of many image classes. When performing retrieval, image classes that assign a high membership probability to positive example images are supported, and image classes that assign a high membership probability to negative example images are penalized. It is to be noted that the authors consider that the positive and the negative examples have the same relative importance. A drawback of the method and system proposed by Vasconcelos is that it doesn't perform any kind of feature weighting of selection. Indeed, it is well known that the importance of features varies from one user to the other and even from one moment to another for the same user. However, this system considers that all features have the same importance.

Picard et al. in “Interactive Learning Using a ‘Society of Models’ from the IEEE Conference on Computer Vision and Pattern Recognition, pages 447-452, San Francisco, 1996., and in “Modeling user subjectivity in image libraries”, Technical Report No. 382, MIT Media Lab Perceptual Computing, 1996, proposed methods involving searching for the set of images similar to positive example, then searching for the set of images similar to negative example; and finally manipulating the two sets in order to obtain the set of images to be returned to the user.

More specifically, Picard et al. teach the organization of database images into many hierarchical trees according to individual features such as color and texture. When the user submits a query, comparison using each of the trees are performed, then the resulting sets are combined by choosing the image sets which most efficiently describe positive example, with the condition that these sets don't describe negative example well.

Belkin et al. in Rutgers' TREC-6 interactive track experience, from the 6th Text Retrieval Conference, pages 597-610, Gaitherburg, USA, 1998 use a Bayesian probabilistic model in which they assume that the relevant features of positive example are good, whether or not they are relevant to negative example. Their interpretation of negative example is that the context in which positive example appears is inappropriate to the searcher's problem. They propose to increase the (positive) weight of the relevant features of positive example (irrespective of their appearance in negative example); and to enhance (with negative weights) the relevant features of negative example which don't appear in positive example.

Belkin et al. consider the negative example at the feature level. They try to identify and enhance the features which help to retrieve images that are at the same time similar to positive example but not similar to negative example. However, enhancing important features of positive example which also appear in negative example can mislead the retrieval process, as will be discussed hereinbelow.

Finally, Nastar et al. in “Relevance Feedback and Category Search in Image Databases.” from the IEEE International Conference on Multimedia Computing and Systems, pages 512-517, Florence, Italy, 1999, and in “Efficient Query Refinement for Image Retrieval.” from the IEEE Conference on Computer Vision and Pattern Recognition, pages 547-552, Santa Barbara, 1998, consider an image database made up of relevant images, among which the user chooses positive example, and non-relevant images, among which the user chooses negative example. A probabilistic model is used to estimate the distribution of relevant images and to simultaneously minimize the probability of retrieving non-relevant images. A drawback of such a model is its interpretation of negative example, and how it confuses between negative example images and non-relevant images. In a real database, most images in general are irrelevant to a given query; however, few of them can be used as negative examples without destroying this query.

### OBJECTS OF THE INVENTION

An object of the present invention is therefore to provide improved content-based image retrieval using positive and negative examples.

### SUMMARY OF THE INVENTION

A content-based method for retrieving data files among a set of database files according to the present invention generally aims at defining a retrieval scenario where the user can select positive example images, negative example images, and their respective degrees of relevance. This allows first to reduce the heterogeneity of the dataset on the basis of the positive example, then to refine the results on the basis of the negative example.

More specifically, in accordance with a first aspect of the present invention, there is provided a content-based method for retrieving data files among a set of database files comprising: providing positive and negative examples of data files; the positive example including at least one relevant feature; providing at least one discriminating feature in at least one of the positive and negative examples allowing to differentiate between the positive and negative examples; for each database file in the set of database files, computing a relevance score based on a similarity of the each database file to the positive example considering the at least one relevant feature; creating a list of relevant files comprising the Nb1 files having the highest similarity score among the set of database files; Nb1 being a predetermined number; for each relevant file in the list of relevant files, computing a discrimination score based on a similarity of the each relevant file to the positive example considering the at least one discriminating feature and on a dissimilarity of the each relevant file to the negative example considering the at least one discriminating feature; and selecting the Nb2 files having the highest discrimination score among the list of relevant files; Nb2 being a predetermined number.

In accordance with a second aspect of the present invention, there is provided a content-based method for retrieving images among a set of database images comprising: providing positive and negative example images; the positive example image including at least one relevant feature; providing at least one discriminating feature in at least one of the positive and negative examples allowing to differentiate between the positive and negative example images; for each database image in the set of database images, computing a relevance score based on a similarity of the each database image to the positive example image considering the at least one relevant feature; creating a list of relevant images comprising the Nb1 images having the highest relevance score among the set of database images; Nb1 being a predetermined number; for each relevant image in the list of relevant images, computing a discrimination score based on a similarity of the each relevant image to the positive example image considering the at least one discriminating feature and on a dissimilarity of the each relevant image to the negative example image considering the at least one discriminating feature; and selecting the Nb2 images having the highest discrimination score among the list of relevant images; Nb2 being a predetermined number.

In accordance with a third aspect of the present invention, there is provided a content-based method for retrieving images among a set of database images, the method comprising: providing positive and negative example images; the positive example image including at least one relevant feature; restricting the set of database images to a subset of images selected among the database images; the images in the subset of images being selected according to their similarity with the positive example based on the at least one relevant feature; retrieving images in the subset of images according to their similarity with the positive example based on the at least one relevant feature and according to their dissimilarity with the negative example based on at least one discriminating feature between the positive and negative examples; whereby, the images retrieved among the database images corresponding to images similar to the positive example and dissimilar to the negative example.

A content-based image retrieval method according to the present invention renders unnecessary the computation of the ideal query since it allows to automatically integrate what the user is looking for into similarity measures without the need to identify any ideal point.

In accordance to a fourth aspect of the present invention, there is provided a content-based system for retrieving images among a set of database images comprising: means for providing positive and negative example images; the positive example image including at least one relevant feature; means for providing at least one discriminating feature in at least one of the positive and negative examples allowing to differentiate between the positive and negative example images; means for computing, for each database image in the set of database images, a relevance score based on a similarity of the each database image to the positive example image considering the at least one relevant feature; means for creating a list of relevant images comprising the Nb₁ images having the highest similarity score among the set of database images; Nb₁ being a predetermined number; means for computing, for each relevant image in the list of relevant images, a discrimination score based on a similarity of the each relevant image to the positive example image considering the at least one discriminating feature and on a dissimilarity of the each relevant image to the negative example image considering the at least one discriminating feature; and means for selecting the Nb₂ images having the highest discrimination score among the list of relevant images; Nb₂ being a predetermined number.

In accordance to a fifth aspect of the present invention, there is provided an apparatus for retrieving images among a set of database images, the apparatus comprising; an interface adapted to receive positive and negative example images; the positive example image including at least one relevant feature; a restriction component operable to restrict the set of database images to a subset of images selected among the database images; the images in the subset of images being selected according to their similarity with the positive example based on the at least one relevant feature; a retrieval component operable to retrieve images in the subset of images according to their similarity with the positive example based on the at least one relevant feature and according to their dissimilarity with the negative example based on at least one discriminating feature between the positive and negative examples; whereby, the images retrieved among the database images correspond to images similar to the positive example and dissimilar to the negative example.

Finally, in accordance to a sixth aspect of the present invention, there is provided a computer readable memory comprising content-based image retrieval logic for retrieving images among a set of database images, the content-based image retrieval logic comprising: image reception logic operable to receive positive and negative example images; the positive example image including at least one relevant feature; restriction logic operable to restrict the set of database images to a subset of images selected among the database images; the images in the subset of images being selected according to their similarity with the positive example based on the at least one relevant feature; and retrieval logic operable to retrieve images in the subset of images according to their similarity with the positive example based on the at least one relevant feature and according to their dissimilarity with the negative example based on at least one discriminating feature between the positive and negative examples; whereby, the images retrieved among the database images correspond to images similar to the positive example and dissimilar to the negative example.

Other objects, advantages and features of the present invention will become more apparent upon reading the following non restrictive description of preferred embodiments thereof, given by way of example only with reference to the accompanying drawings.

### BRIEF DESCRIPTION OF THE DRAWINGS

In the appended drawings:

FIG. 1 is a flowchart illustrating a content-based image retrieval method according to an illustrative embodiment of the present invention;

FIG. 2 is a graph illustrating precision-scope curves for two cases: negative example in two steps according to the method of FIG. 1 and negative example in one step according to the prior art;

FIG. 3 is a computer screenshot of a graphical interface displaying sample images related to different subjects and emphasizing different features;

FIG. 4 is a computer screenshot of a query screen from a user-interface allowing a person to characterized example images according to the method of FIG. 1;

FIG. 5 is a schematic view illustrating the decomposition of the HIS color space into a set of subspaces and the computation of each subspace's histogram;

FIG. 6 is a graph illustrating a positive average, a negative average, and the resulting overall query average;

FIG. 7 is a graph illustrating the minimization of the global dispersion leading to neglect the relevant features of negative example;

FIG. 8, which is labeled “Prior Art”, is a graph illustrating the minimization of the dispersion of positive example, the minimization of negative example and the minimization of the distinction between them according to a method from the prior art;

FIG. 9 is a screenshot illustrating the result following step 106 from the method of FIG. 2;

FIG. 10 is a screenshot illustrating the result following step 112 from the method of FIG. 2;

FIG. 11 is a graph illustrating precision-scope curves for retrieval with positive example and refinement with negative example; and

FIG. 12 is a table showing the number of iterations needed to locate a given category of images in two cases: using positive example only and using both positive and negative examples according to the method of FIG. 2.

### DETAILED DESCRIPTION OF THE INVENTION

A content-based image retrieval method according to the present invention involves relevance feedback using negative examples. The negative examples are considered from the feature point of view, and used to identify the most discriminating features according to a user-given query.

A content-based image retrieval method according to the present invention makes use of decision rules including characteristic rules and discrimination rules will now be briefly explained. A characteristic rule of a set is an assertion which characterizes a concept satisfied by all or most of the members of this set. For example, the symptoms of a specific disease can be summarized by a characteristic rule. A discrimination rule is an assertion which discriminates a concept of the target set from the rest of the database. For example, to distinguish one disease from others, a discrimination rule should summarize the symptoms that discriminate this disease from others.

In applying a content-based image retrieval method according to the present invention, it is assumed that positive and negative examples possess some relevant features that are discriminant, i.e., relevant to either positive or negative example or to both but whose values are not the same in positive and in negative examples. In other words, the case in which the relevant features of positive example are the same as those of negative example, with similar values is excluded. Such a case would yield an ambiguous query. A system implementing a content-based image retrieval method according to the present invention is programmed to reject such a case and to prompt and allow the user to specify new relevant features.

To implement the above described principle, characteristic rules may first be extracted from positive example images by the identification of their relevant features. More importance should then be given to such features in the retrieval process and images enhancing them should be retrieved. Secondly, discrimination rules can be extracted from the difference between positive example and negative example. Relevant features whose values are not common to positive and negative examples are good discriminators, and hence must be given more importance; conversely, common features are not good discriminators, and must be penalized. However, applying this principle in this manner, may render misleading the retrieval process by neglecting certain relevant features of positive and negative examples, as explained below.

Before describing in details a content-based image retrieval method according to the present invention, which would solve the problem presented hereinabove, the concept of relevant feature will be define in more detail. A given feature is considered relevant if it helps retrieving the images being sought. This will depend on two factors.

First, the relevance can be considered with respect to the query. A feature relevant to the query is a feature which is salient in the majority of the query images. A feature to be considered is a feature whose values are concentrated in the query images, and which discriminates well between positive and negative examples, as relevant to the query.

Second, the relevance of a feature can be considered with respect to the database. If a given feature's values are almost the same for the majority of the database images, then this feature is considered to be not relevant since it doesn't allow to distinguish the sought images from the others; and vice versa. To illustrate this, consider a database in which each image contains an object with a circular shape, but where the color of the object differs from one image to another. In such a database, the shape feature is not interesting for retrieval since it doesn't allow to distinguish between desired and undesired images; however, the color feature is interesting. In other words, a feature in term of which the database is homogeneous is considered not relevant for retrieval; whereas, a feature in term of which the database is heterogeneous is considered relevant.

In the following, the consequences of neglecting features whose values are common to both positive and negative examples is analyzed. In fact, this depends on the nature of the database. If the database is homogeneous in terms of such features, then neglecting them will not be detrimental since they are not relevant to the database. On the other hand, if the database is heterogeneous in terms of these features, then neglecting them will lead the system to retrieve many undesired images and to miss many desired images.

From the above, it is clear that common features should be considered to develop a solution that works for any query. However, in some cases, there are not enough common features to be considered alone at a given moment; they must rather be considered together with other features.

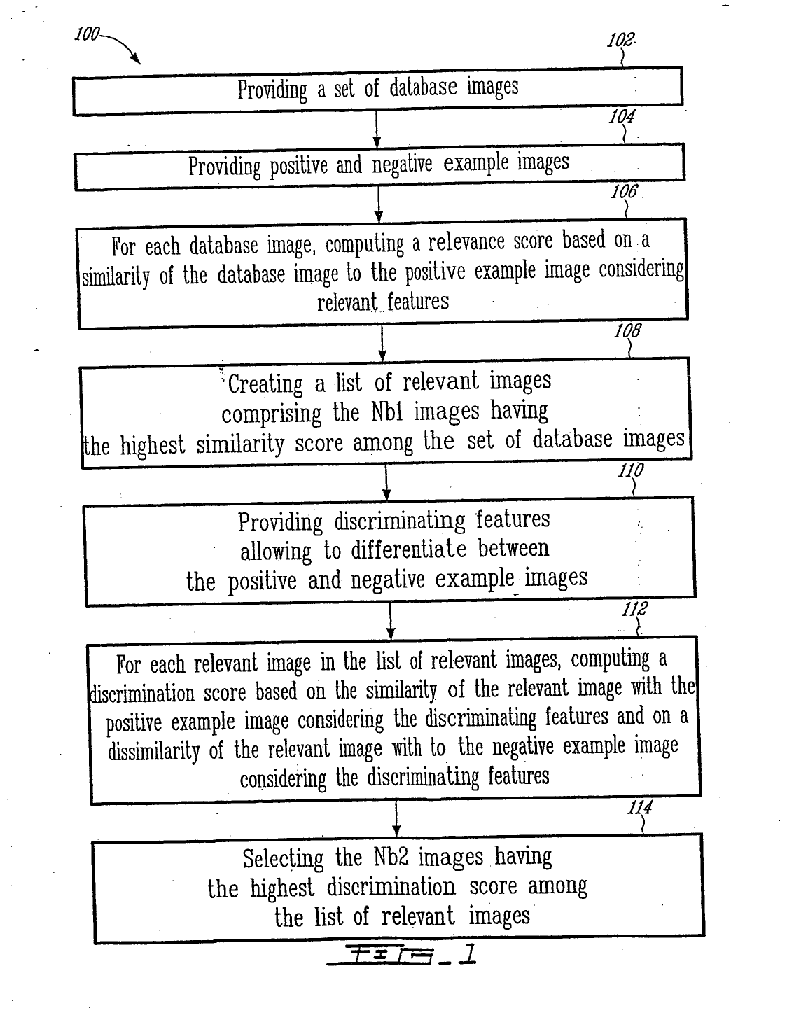

Turning now to FIG. 1 of the appended drawings, a content-based image retrieval method 100 according to a first illustrative embodiment of the present invention is illustrated.

Generally stated the method 100 consists in performing the following steps:

102—providing a set of database images;

104—providing positive and negative example images;

106—for each database image, computing a relevance score based on a similarity of the database image to the positive example image considering relevant features;

108—creating a list of relevant images comprising the Nb₁ images having the highest relevance score among the set of database images;

110—providing discriminating features allowing to differentiate between the positive and negative example images;

112—for each relevant image in the list of relevant images, computing a discrimination score based on the similarity of the relevant image with the positive example image considering the discriminating features and on a dissimilarity of the relevant image with to the negative example image considering the discriminating features; and

114—selecting the Nb2 images having the highest discrimination score among the list of relevant images.

It can be useful to described a content-based image retrieval method according to the present invention as including two general steps. In the following, we will refer to the steps of the method 100 using referral numbers and we will refer to the more general steps using the expressions: first and second general steps.

The first general step allows to reduce the heterogeneity of the set of images participating in the retrieval by restricting it to a more homogeneous subset according to positive example relevant features (and thus according to common features also). In this first general step, we enhance all the relevant features of positive example. We rank the database images according to their resemblance to positive example and then retain only the Nb₁ top-ranked images, where Nb₁ is a predetermined number.

Only images retained in the first general step will participate in the refinement performed in the second general step, where we enhance the discrimination features, i.e., those whose values are not common to positive and negative examples. In this second general step we rank the candidate images according to their similarity to positive example and dissimilarity to negative example, and return to the user only the Nb₂ (Nb₂<Nb₁) top-ranked images. Hence, even if the common features are neglected in the second general step, this will not mislead the retrieval since they were considered in the first general step. As will be presented hereinbelow in more detail, we confirmed experimentally, using a retrieval system implementing the present method, the importance of processing queries with negative example in two steps.

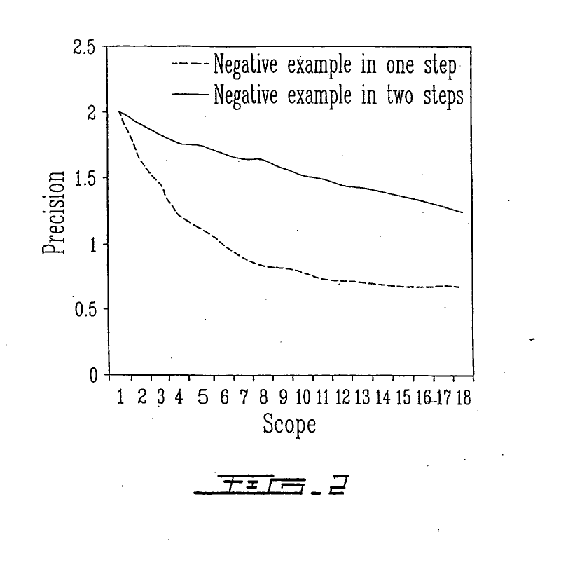

FIG. 2 compares the curves precision-scope for the two techniques: negative example queries processed in two general steps according to a content-based image retrieval according to the present invention versus negative example queries processed in a unique step (in which both positive and negative examples are considered and all images in the database participate in retrieval) according to methods from the prior art. The ordinate “Precision” represents the average of relevance of retrieved images, and “scope” is the number of retrieved images. It is clear from FIG. 1 that when queries containing negative example are considered in one step, the precision of retrieval decreases quickly with the number of retrieved images.

Before describing each of the steps 102-114 of the method 100, some special cases are important and merit to be mentioned to show that the proposed image retrieval method functions as well. These cases emerge when all the discrimination features come from positive example only or from negative example only. Indeed, if the relevant features of positive example are strictly included in those of negative example and with common values, then applying the proposed principle leads, in the general first step, to enhance the relevant features of positive example (which are the same as the common features) and to retain images looking like it. Then, in the second general step, to enhance the rest of the negative example relevant features and to discard images near to it. On the other hand, if the relevant features of negative example are strictly included in those of positive example and with common values, then applying the proposed principle leads, in the first general step, to enhance the relevant features positive example (which include those of negative example) and to retain images looking like the positive example. Then, in the second general step, to enhance only those features relevant to positive but not to negative example and to re-rank the images according to these features essentially.

The following will explained how the content base image retrieval method 100 may allow a user to compose a query using negative example only.

First, we note that, for a given query, the number of non-relevant images is usually much higher than the number of relevant images. In other words, if we know what someone doesn't want, this doesn't inform us sufficiently about what the user wants. For example, if the user gives an image of a car as negative example without giving any positive example, then we cannot know whether the user is looking for images of buildings, animals, persons or other things. Nevertheless, negative example can be used alone in some cases, for instance, to eliminate a subset from a database, for example, when a database contains, in addition to images the user agrees with, other images that the user's culture doesn't tolerate, e.g. nudity images for some persons. In such a case, the user can first eliminate the undesired images by using some of them as negative example; then the user can navigate in, or retrieve from the rest of the database. Concerning the retrieval method, the negative-example-only query will be considered as a positive example query, i.e., the system first searches for images that resemble negative example. Then, when the resulting images (images that the user wants to discard) are retrieved, the system returns to the user the rest of the database rather these images.

Each of the steps 102-114 of the method 100 will now be described in more detail.

In step 102, a set of database images is provided to or by a user, among the set of images possibly including images that the user wants to retrieve.

Then, in step 104, positive and negative example images are provided through interaction between the user and the system implementing the method 100. Of course, the person seeking images having specific features can alternatively select the example images manually. In that case, the selected images are digitized afterwards.

The user interaction aims to achieve two main objectives. First, to be able to combine the query images together with their respective degrees of relevance in order to identify what the user is looking for; and to integrate this information in similarity measures. Second, to weight each predetermined feature and its components according to its relevance to the query and the discrimination power it can provide.

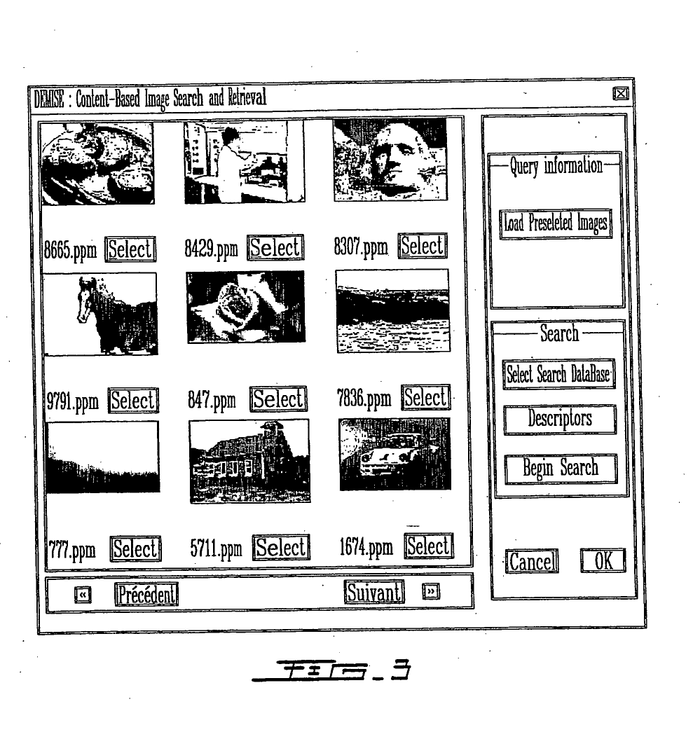

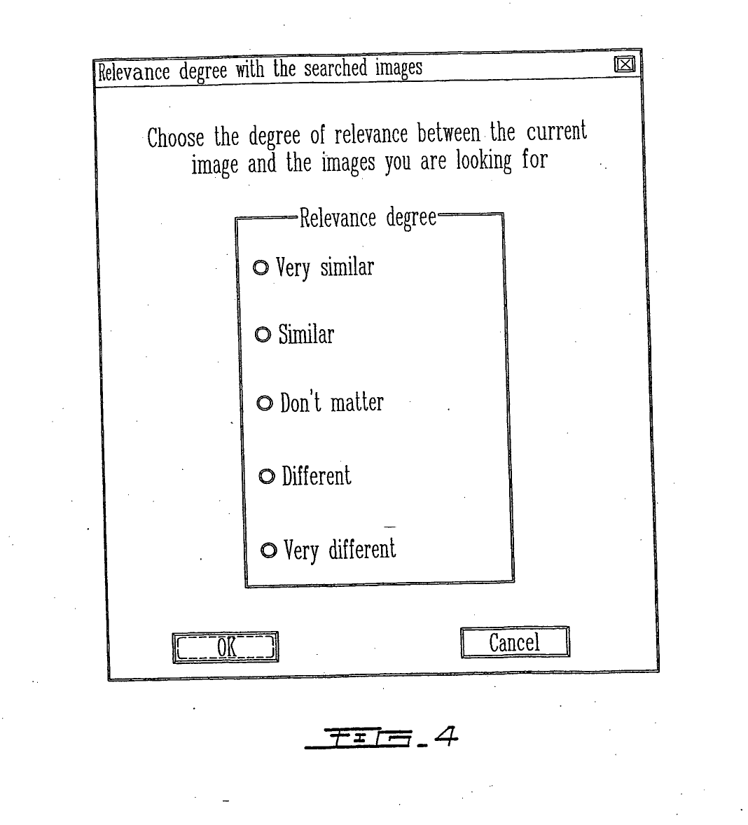

FIG. 3 illustrates a graphical interface displaying nine sample images related to different subjects and emphasizing different features. The graphical interface is programmed so as to allow a user to choose additional images from the database before formulating the query. To select an image as an example image (or query image), the user may click on the “Select” button. The system displays a dialog box allowing the user to specify a degree of relevance (see FIG. 4). The user-interface illustrated in FIG. 4 allows a person to characterize selected example images.

For each selected images, the possible relevance degrees are
Very similar: corresponds to the relevance value 2 for a positive example image;
Similar: corresponds to the relevance value 1 for a positive example image;
Doesn't matter: the image will not participate in the query;
Different: corresponds to the relevance value 1 for a negative example image; or
Very different: corresponds to the relevance value 2 for a negative example image.

Of course, the relevancy of each image can be characterized with more or less finesse.

Before explaining in more detail the formulation of relevance feedback, an example of image model and similarity measure will be described. Of course, another image model can alternatively be used.

To represent images, the hierarchical model proposed by Rui et al. is used. According to this model, each image, either in the query or in the database, is represented by a set of I features, each of which is a real vector of many components. It has been found that this image model ensures a good modeling of both images and image features, and a reduction in the computation time. According to this hierarchical two-level image model, a distance metric for each level is selected. For feature level, a generalized Euclidean distance function is chosen, as in Ishikawa et al. If \vec{x}ₙ and \vec{x}ᵢ₂ are the i^{th} feature vectors of the images x₁ and x₂ respectively, then the distance at this feature level is
Dᵢ(\vec{x}ᵢ₁, \vec{x}ᵢ₂)=(\vec{x}ᵢₗ−\vec{x}ᵢ₂)^{T}Wᵢ(\vec{x}ᵢ₁−\vec{x}ᵢ₂) (4)
where Wᵢ is a symmetric matrix that allows us to define the generalized ellipsoid distance Dᵢ.

The choice of this distance metric allows not only to weight each feature's component but also to transform the initial feature space into a space that better models the user's needs and specificities. The global distance between two images x₁ and x₂ is linear and is given by

$$D ( {x}_{1} , {x}_{2} ) = {\sum }_{i = 1}^{I} {{u}_{i} ( {\vec{x}}_{1 i} - {\vec{x}}_{2 i} )}^{T} {W}_{i} ( {\vec{x}}_{1 i} - {\vec{x}}_{2 i} ) \qquad ( 5 )$$

where uᵢ is the global weight assigned to the i^{th} feature.

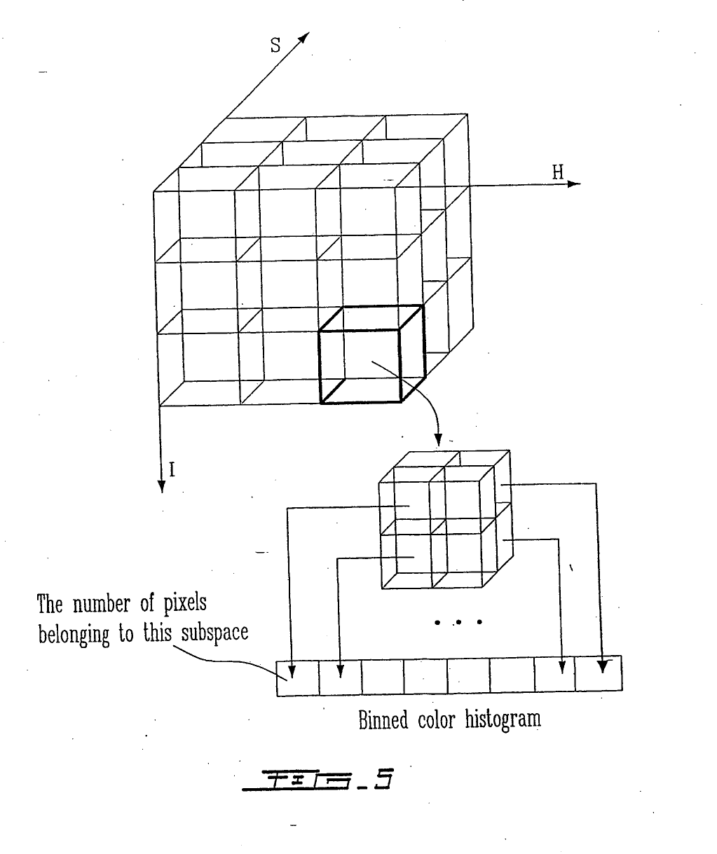

Each image, either in the database or in the query, is represented by a set of 27 feature vectors, computed as follows: First, every pixel in the image is mapped to a point in the three-dimensional (3D) HSI space (FIG. 5). This operation consists of computing, for every triple [H,S,I], the number of pixels having the values Hue=H, Saturation=S and Intensity=I. This yields a 3D color histogram that takes up a lot of space and having zeros for most of its values. For example, an image with HSI values ranging between 0 and 255, would yield a histogram containing 256³ cells, most of which not corresponding to any pixel.

To reduce the histogram's size, many solutions are possible, such as the spatial repartition of the points of the 3-D histogram, taking into account their respective occurrence frequency, i.e., the number of pixels corresponding to each point in the histogram. However, since the method 100 does not aim at finding the best visual features, a compromise consists in partitioning the space by subdividing the axes H, S and I into three equal intervals each. This gives 3³=27 subspaces, as shown in FIG. 5. Each subspace constitutes a feature, and its corresponding vector is computed as follows. The subspace is subdivided into 2³=8 sub-subspaces. The sum of the elements of each sub-subspace is computed and the result is stored in the corresponding cell of the feature vector

Alternatively, the images can be represented using other models.

In step 106, a relevance score is computed for each database image based on the similarity of the image to the positive example image considering the relevant feature.

Considering that the user constructs a query composed of N₁ positive example images and their respective relevance degrees πₙ¹ for n=1, . . . ,N₁, as well as N₂ negative example images and their respective relevance degrees πₙ² for n=1, . . . ,N₂. (It should be noted that πₙ² is not the square of πₙ; 2 is an index designating the negative example).

Only the positive examples are considered in step 106. Each relevance feature and its components is enhanced according to its relevance to the positive example. This can be done by introducing the optimal parameters uᵢ and Wᵢ which minimize Jₚₒₛᵢₜᵢᵥₑ, the global dispersion of positive example, given in Equation (6).

$${J}_{positive} = {\sum }_{i = 1}^{I} {u}_{i} {\sum }_{n = 1}^{{N}_{1}} {{π}_{n}^{1} ( {\vec{x}}_{ni}^{1} - {\vec{\overline{x}}}_{i}^{1} )}^{T} {W}_{i} ( {\vec{x}}_{ni}^{1} - {\vec{\overline{x}}}_{i}^{1} ) \qquad ( 6 )$$

where \overline{\vec{x}}ᵢ¹ is the weighted average of positive example (see FIG. 6), given by

$${\vec{\overline{x}}}_{i}^{1} = \frac{{\sum }_{n = 1}^{{N}_{1}} {π}_{n}^{1} {x}_{ni}^{1}}{{\sum }_{n = 1}^{{N}_{1}} {π}_{n}^{1}} \qquad ( 7 )$$

An image retrieval method according to the present invention allows to give more weight to features and feature components for which the positive example images are close to each other in the feature space. An informal justification is that if the variance of query images is high along a given. axis, any value on this axis is apparently acceptable to the user, and therefore this axis should be given a low weight, and vice versa.

In step 108, the database images are ranked in increasing order according to a relevance score based on a similarity of each database image to the positive example image considering the relevance features

More specifically a distance from the positive example average and the Nb₁ top-ranked images is computed are kept for the next steps. This distance is given by Equation (8).

$$D ( {x}_{n} ) = {\sum }_{i = 1}^{I} {{u}_{i} ( {\vec{x}}_{ni} - {\vec{\overline{x}}}_{i}^{1} )}^{T} {W}_{i} ( {\vec{x}}_{ni} - {\vec{\overline{x}}}_{i}^{1} ) \qquad ( 8 )$$

If the query contains only negative example images, then the system proceeds initially by a similar procedure, but considering the negative example rather than the positive example. This means that the system computes the ideal parameters which minimize the dispersion of negative example images, ranks the images in increasing order according to their distance from the negative example average, then returns to the user the last-ranked images. If the query contains both positive and negative examples, then the system performs the two steps of retrieval. The parameter computation and the distance function used in the first step are the same as in the case of a positive-example-only query.

In the second general step, both positive and negative example images are considered, and the refinement concerns the images retained in the first general step and more specifically in step 108.

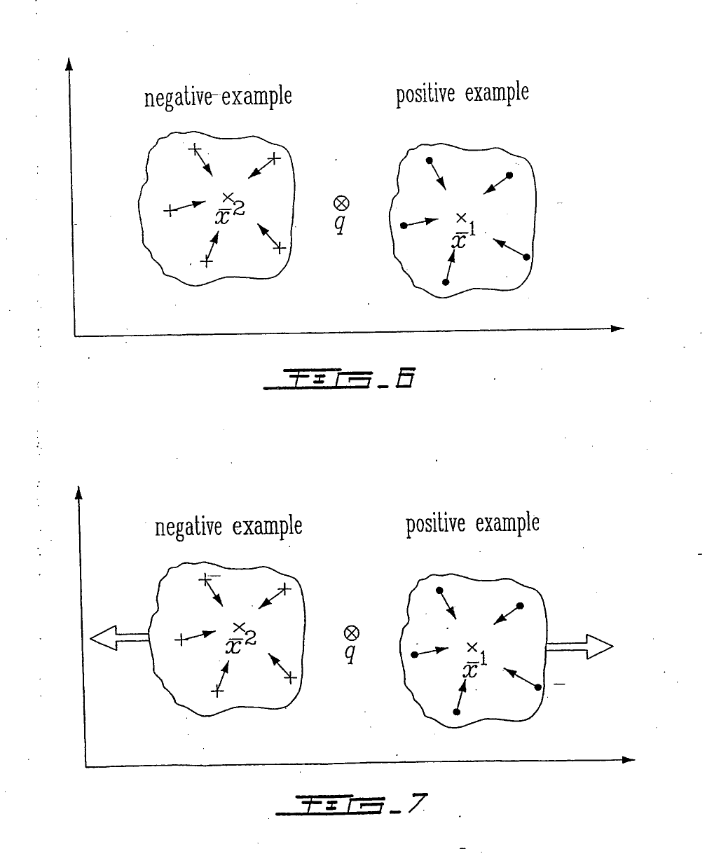

First J_{gIobal}, the global dispersion of the query, including positive and negative example images is defined:

$${J}_{global} = {\sum }_{i = 1}^{I} {u}_{i} {\sum }_{k = 1}^{2} {\sum }_{n = 1}^{{N}_{k}} {{π}_{n}^{k} ( {\vec{x}}_{ni}^{k} - {\vec{q}}_{i} )}^{T} {W}_{i} ( {\vec{x}}_{ni}^{k} - {\vec{q}}_{i} ) \qquad ( 9 )$$

where k=1 for positive example and k=2 for negative example, and where \vec{q}ᵢ, given in Equation (10), is the weighted average of all query images for the i^{th} feature (see FIG. 7).

$${\vec{q}}_{i} = \frac{{\sum }_{k = 1}^{2} {\sum }_{n = 1}^{{N}_{k}} {π}_{n}^{k} {\vec{x}}_{ni}^{k}}{{\sum }_{k = 1}^{2} {\sum }_{n = 1}^{{N}_{k}} {π}_{n}^{k}} \qquad ( 10 )$$

In Rui et al. (2), it is proposed to allocate negative degrees of relevance to negative example images and to compute the parameters which minimize the same expression of Equation (9). The consequences of such an approach, which is not adopted in a content-based image retrieval method according to the present invention, will now be considered in order to emphasis the differences such an approach and the one used in the method 100. If positive example are considered separately from negative example in Equation (9), then:

$${J}_{global} = {\sum }_{i = 1}^{I} {u}_{i} {\sum }_{n = 1}^{{N}_{1}} {{π}_{n}^{1} ( {\vec{x}}_{ni}^{1} - {\vec{q}}_{i} )}^{T} {W}_{i} ( {\vec{x}}_{ni}^{1} - {\vec{q}}_{i} ) + {\sum }_{i = 1}^{I} {u}_{i} {\sum }_{n = 1}^{{N}_{2}} {{π}_{n}^{2} ( {\vec{x}}_{ni}^{2} - {\vec{q}}_{i} )}^{T} {W}_{i} ( {\vec{x}}_{ni}^{2} - {\vec{q}}_{i} ) \qquad ( 11 )$$

Rui et al. (2) choose πₙ¹>0 for n=1 , . . . ,N₁ and πₙ²<0 for n=1, . . . ,N₂, yielding:

$${J}_{global} = {\sum }_{i = 1}^{I} {u}_{i} {\sum }_{n = 1}^{{N}_{1}} {{π}_{n}^{1} ( {\vec{x}}_{ni}^{1} - {\vec{q}}_{i} )}^{T} {W}_{i} ( {\vec{x}}_{ni}^{1} - {\vec{q}}_{i} ) - {\sum }_{i = 1}^{I} {u}_{i} {\sum }_{n = 1}^{{N}_{2}} \vert {π}_{n}^{2} \vert {( {\vec{x}}_{ni}^{2} - {\vec{q}}_{i} )}^{T} {W}_{i} ( {\vec{x}}_{ni}^{2} - {\vec{q}}_{i} ) \qquad ( 12 )$$

where |πₙ²| designates the absolute value of πₙ². Equation (12) shows that the global dispersion J_{global} is the dispersion of positive example minus the dispersion of negative example. Hence, by minimizing the global dispersion, even if Rui et al. (2) move the global query average q (with which they compare their images) towards positive example and away from negative example, two problems emerge.

First, minimizing the global dispersion will lead to minimize the dispersion of positive example, but with respect to the global query average q rather than the positive example average \overline{x}₁. This will not give an optimal minimization of the positive example dispersion; and hence, the relevant features of positive example will not be given enough importance.

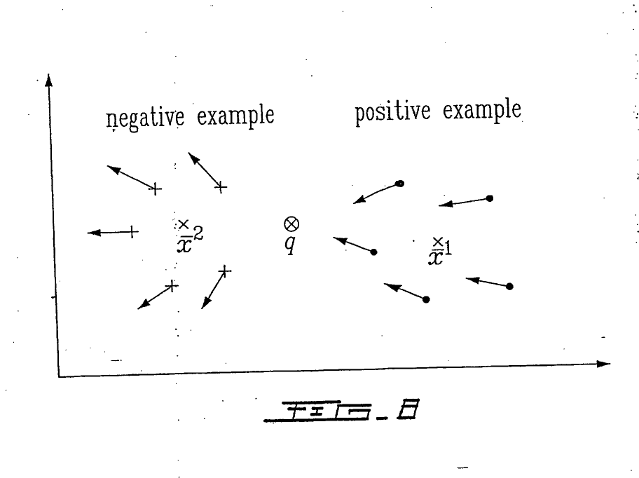

Second, minimizing the global dispersion will lead to maximize the dispersion of negative example. This implies that they neglect the relevant features of negative example. Hence, their retrieval system will not be able to discard the undesired images. This is illustrated in FIG. 8.

The weights uᵢ and Wᵢ are introduced to give more importance to the relevant features of either positive or negative example which allow to distinguish well between them. In other words, via uᵢ and Wᵢ, weights are attributed to features and the feature space is transformed into a new space in which positive example images are as close as possible, negative example images are as close as possible, and positive example is as far as possible from negative example (see FIG. 7). These objectives are translated into a mathematical formulation, by first distinguishing positive example images from negative example images in the global dispersion formula of Equation (9). For each feature i, the weighted average of positive example images \overline{\vec{x}}ᵢ¹ is recalled and the weighted average of negative example images \overline{\vec{x}}ᵢ² in Equations (13) and (14) respectively is defined.

$$\begin{matrix}{\vec{\overline{x}}}_{i}^{1} = \frac{{\sum }_{n = 1}^{{N}_{1}} {π}_{n}^{1} {x}_{ni}^{1}}{{\sum }_{n = 1}^{{N}_{1}} {π}_{n}^{1}} & ( 13 ) \\ {\vec{\overline{x}}}_{i}^{2} = \frac{{\sum }_{n = 1}^{{N}_{2}} {π}_{n}^{2} {x}_{ni}^{2}}{{\sum }_{n = 1}^{{N}_{2}} {π}_{n}^{2}} & ( 14 )\end{matrix}$$

By introducing \overline{\vec{x}}ᵢ¹ and \overline{\vec{x}}ᵢ² into Equation (9), one can rewrite it as follows:

$${J}_{global} = {\sum }_{i = 1}^{I} {u}_{i} {\sum }_{k = 1}^{2} {\sum }_{n = 1}^{{N}_{k}} {{π}_{n}^{k} [ ( {\vec{x}}_{ni}^{k} - {\vec{\overline{x}}}_{i}^{k} ) + ( {\vec{\overline{x}}}_{i}^{k} - {\vec{q}}_{i} ) ]}^{T} {W}_{i} [ ( {\vec{x}}_{ni}^{k} - {\vec{\overline{x}}}_{i}^{k} ) + ( {\vec{\overline{x}}}_{i}^{k} - {\vec{q}}_{i} ) ] \qquad ( 15 )$$

Developing Equation (15) gives

$${J}_{global} = {\sum }_{i = 1}^{I} {u}_{i} [ ( {\sum }_{k = 1}^{2} {\sum }_{n = 1}^{{N}_{k}} {{π}_{n}^{k} ( {\vec{x}}_{ni}^{k} - {\vec{\overline{x}}}_{i}^{k} )}^{T} {W}_{i} ( {\vec{x}}_{ni}^{k} - {\vec{\overline{x}}}_{i}^{k} ) ) + ( {\sum }_{k = 1}^{2} {\sum }_{n = 1}^{{N}_{k}} {{π}_{n}^{k} ( {\vec{x}}_{ni}^{k} - {\vec{\overline{x}}}_{i}^{k} )}^{T} {W}_{i} ( {\vec{\overline{x}}}_{i}^{k} - {\vec{q}}_{i} ) ) + ( {\sum }_{k = 1}^{2} {\sum }_{n = 1}^{{N}_{k}} {{π}_{n}^{k} ( {\vec{\overline{x}}}_{i}^{k} - {\vec{q}}_{i} )}^{T} {W}_{i} ( {\vec{x}}_{ni}^{k} - {\vec{\overline{x}}}_{i}^{k} ) ) + ( {\sum }_{k = 1}^{2} {\sum }_{n = 1}^{{N}_{k}} {{π}_{n}^{k} ( {\vec{\overline{x}}}_{i}^{k} - {\vec{q}}_{i} )}^{T} {W}_{i} ( {\vec{\overline{x}}}_{i}^{k} - {\vec{q}}_{i} ) ) ] \qquad ( 16 )$$

It can easily be shown that the second and third parts of Equation (16) are zero. For example, the second part
Σₖ₌₁²Σₙ₌₁^{N}^{ₖ}πₙ^{k}(\vec{x}ₙᵢ^{k}−\overline{\vec{x}}ᵢ^{k})^{T}Wᵢ(\overline{\vec{x}}ᵢ^{k}−\vec{q}ᵢ)=Σₖ₌₁²[(Σₙ₌₁^{N}^{ₖ}πₙ^{k}(\vec{x}ₙᵢ^{k}−\overline{\vec{x}}ᵢ^{k})^{T})Wᵢ(\overline{\vec{x}}ᵢ^{k}−\vec{q}ᵢ)]=Σₖ₌₁²[((Σₙ₌₁^{N}^{ₖ}πₙ^{k}\vec{x}ₙᵢ^{k})−(Σₙ₌₁^{N}^{ₖ}πₙ^{k})\overline{\vec{x}}ᵢ^{k})^{T}Wᵢ(\overline{+E,rar}ᵢ^{k}−\vec{q}ᵢ)]=0
since, according to Equations (13) and (14),
Σₙ₌₁^{N}^{ₖ}πₙ^{k}xₙᵢ^{k}−(Σₙ₌₁^{N}^{ₖ}πₙ^{k})\overline{\vec{x}}ᵢ^{k}=0

Thus, Equation (17) can be written as follows:

$${J}_{global} = [ {\sum }_{i = 1}^{I} {u}_{i} {\sum }_{k = 1}^{2} {\sum }_{n = 1}^{{N}_{k}} {{π}_{n}^{k} ( {\vec{x}}_{ni}^{k} - {\vec{\overline{x}}}_{i}^{k} )}^{T} {W}_{i} ( {\vec{x}}_{ni}^{k} - {\vec{\overline{x}}}_{i}^{k} ) ] + [ {\sum }_{i = 1}^{I} {u}_{i} {\sum }_{k = 1}^{2} {\sum }_{n = 1}^{{N}_{k}} {{π}_{n}^{k} ( {\vec{\overline{x}}}_{i}^{k} - {\vec{q}}_{i} )}^{T} {W}_{i} ( {\vec{\overline{x}}}_{i}^{k} - {\vec{q}}_{i} ) ] = A + R \qquad ( 17 )$$

The first term “A” expresses the positive example internal dispersion, i.e., how close positive example images are to each other, added to the negative example internal dispersion, i.e., how close negative example images are to each other. The second term “R” expresses the distance between the two sets, i.e., how far positive example is from negative example.

By distinguishing the intra dispersion “A” from the inter dispersion “R”, it is now clearer how one can formulate the above-identified objectives in a mathematical problem. In fact, one want to compute the model parameters, namely uᵢ and Wᵢ, which minimize the intra dispersion “A” and maximize the inter dispersion “R”. Several combinations of A and R are possible.

The parameters which minimize the ratio

$$\frac{A}{R} ,$$

assuming that R≠0 will be computed. In the case of R=0, the positive example and the negative example are not distinguishable and the query is ambiguous. In such case, the query is rejected and the user is asked to formulate a new one. Furthermore, to avoid numerical stability problems, the following two constraints are introduced:

$${\sum }_{i = 1}^{I} \frac{1}{{u}_{i}} = 1$$

and det(Wᵢ)=1 for all i=1, . . . ,I. By using Lagrange multipliers, the optimal parameters uᵢ and Wᵢ must minimize the quantity L given in Equation (18).

$$\begin{matrix}L = \frac{A}{R} = λ ( {\sum }_{i = 1}^{I} \frac{1}{{u}_{i}} - 1 ) - {\sum }_{i = 1}^{I} {λ}_{i} ( det ( {W}_{i} ) - 1 ) \\ where & ( 18 ) \\ A = {\sum }_{i = 1}^{I} {u}_{i} {\sum }_{k = 1}^{2} {\sum }_{n = 1}^{{N}_{k}} {{π}_{n}^{k} ( {\vec{x}}_{ni}^{k} - {\vec{\overline{x}}}_{i}^{k} )}^{T} {W}_{i} ( {\vec{x}}_{ni}^{k} - {\vec{\overline{x}}}_{i}^{k} ) \\ and & ( 19 ) \\ R = {\sum }_{i = 1}^{I} {u}_{i} {\sum }_{k = 1}^{2} {{\tilde{π}}^{k} ( {\vec{\overline{x}}}_{i}^{k} - {\vec{q}}_{i} )}^{T} {W}_{i} ( {\vec{\overline{x}}}_{i}^{k} - {\vec{q}}_{i} ) & ( 20 )\end{matrix}$$

\tilde{π}¹ denotes the sum of positive example relevance degrees, i.e., \tilde{π}¹=Σₙ₌₁^{N}^{₁}πₙ¹ and \tilde{π}² denotes the sum of negative example relevance degrees, i.e., \tilde{π}²=Σₙ₌₁^{N}^{₂}πₙ².

The optimization problem in order to obtain the optimal parameters uᵢ and Wᵢ will now be resolved.

It is to be noted first that the relative importance of positive and negative examples are to be determined, i.e., \tilde{π}¹ with respect to \tilde{π}². Some image retrieval systems, such as the one described by Müller et al. adopt the values used by certain text retrieval systems which are 0.65 for positive example and 0.35 for negative example. Other systems such as the one described by Vasconcelos et al. assume that positive example and negative example have the same importance. In the method 100, the latter choice is adopted because it allows some simplifications in the derivation of the problem. Furthermore, all the user-given relevance degrees are normalized so that \tilde{π}¹+\tilde{π}²=1.

To obtain the optimal solution for Wᵢ, the partial derivative of L with respect to wᵢ_{ᵣₛ} for r,s=1, . . . ,Hᵢ, is taken where Hᵢ is the dimension of the i^{th} feature and wᵢ_{ᵣₛ} is the rs^{th} element of Wᵢ, i.e., Wᵢ=[wᵢ_{ᵣₛ}], yielding

$$\begin{matrix}\frac{\partial L}{\partial {w}_{{i}_{rs}}} = \frac{R \frac{\partial A}{\partial {w}_{{i}_{rs}}} - A \frac{\partial R}{\partial {w}_{{i}_{rs}}}}{{R}^{2}} - {λ}_{i} \frac{\partial det ( {W}_{i} )}{\partial {w}_{{i}_{rs}}} \\ where & ( 21 ) \\ \frac{\partial A}{\partial {w}_{{i}_{rs}}} = {u}_{i} {\sum }_{k = 1}^{2} {\sum }_{n = 1}^{{N}_{k}} {π}_{n}^{k} ( {x}_{{ni}_{r}}^{k} - {\overline{x}}_{{i}_{r}}^{k} ) ( {x}_{{ni}_{s}}^{k} - {\overline{x}}_{{i}_{s}}^{k} ) \\ and & ( 22 ) \\ \frac{\partial R}{\partial {w}_{{i}_{rs}}} = {u}_{i} {\sum }_{k = 1}^{2} {\tilde{π}}^{k} ( {\overline{x}}_{{i}_{r}}^{k} - {q}_{{i}_{r}} ) ( {\overline{x}}_{{i}_{s}}^{k} - {q}_{{i}_{s}} ) & ( 23 )\end{matrix}$$

Before computing

$$\frac{\partial L}{\partial {w}_{{i}_{rs}}} ,$$

it is to be noted that det(Wᵢ)=Σᵣ₌₁^{H}^{ᵢ}(−1)^{r+s}wᵢ_{ᵣₛ} det(Wᵢ_{ᵣₛ}⁻), where det(Wᵢ_{ᵣₛ}) is the rs^{th} minor of Wᵢ obtained by eliminating the r^{th} row and the s^{th} column of det(Wᵢ). Hence,

$$\frac{\partial det ( {W}_{i} )}{\partial {w}_{{i}_{rs}}} = {( - 1 )}^{r + s} det ( {W}_{{i}_{rs}} ) \qquad ( 24 )$$

By substituting Equations (19), (20) and (21) in (18), we obtain

$$\frac{\partial L}{\partial {w}_{{i}_{rs}}} = 0 ⇔ \\ R [ {u}_{i} {\sum }_{k = 1}^{2} {\sum }_{n = 1}^{{N}_{k}} {π}_{n}^{k} ( {x}_{{ni}_{r}}^{k} - {\overline{x}}_{{i}_{r}}^{k} ) ( {x}_{{ni}_{s}}^{k} - {\overline{x}}_{{i}_{s}}^{k} ) ] - A [ {u}_{i} {\sum }_{k = 1}^{2} {\overline{π}}^{k} ( {x}_{{i}_{r}}^{k} - {q}_{{i}_{r}} ) ( {\overline{x}}_{{i}_{s}}^{k} - {q}_{{i}_{s}} ) ] - {R}^{2} {{λ}_{i} ( - 1 )}^{r + s} det ( {W}_{{i}_{rs}} ) = 0 ⇔ det ( {W}_{{i}_{rs}} ) = \frac{{u}_{i}}{{( - 1 )}^{r + s} {λ}_{i} {R}^{2}} [ R {\sum }_{k = 1}^{2} {\sum }_{n = 1}^{{N}_{k}} {π}_{n}^{k} ( {x}_{{ni}_{r}}^{k} - {\overline{x}}_{{i}_{r}}^{k} ) ( {x}_{{ni}_{s}}^{k} - {\overline{x}}_{{i}_{s}}^{k} ) - A {\sum }_{k = 1}^{2} {\overline{π}}^{k} ( {\overline{x}}_{{i}_{r}}^{k} - {q}_{{i}_{r}} ) ( {\overline{x}}_{{i}_{s}}^{k} - {q}_{{i}_{s}} ) ] \qquad ( 25 )$$

Now consider the matrix Wᵢ⁻¹=[wᵢ_{ᵣₛ}⁻¹], the inverse matrix of W₁ (provided that Wᵢ is invertible). To obtain the value of each component wᵢ_{ᵣₛ}⁻¹, the determinant method for matrix inversion is used to obtain

$${w}_{{i}_{rs}}^{- 1} = \frac{{( - 1 )}^{r + s} det ( {W}_{{i}_{rs}} )}{det ( {W}_{i} )}$$

Knowing that det(W₁)=1 yields

$${w}_{{i}_{rs}}^{- 1} = {( - 1 )}^{r + s} det ( {W}_{{i}_{rs}} ) \qquad ( 26 )$$

In Equation (26), det(Wᵢ_{ᵣₛ}) is replaced by its value from Equation (25) to obtain

$${w}_{{i}_{rs}}^{- 1} = \frac{1}{γ} [ R {\sum }_{k = 1}^{2} {\sum }_{n = 1}^{{N}_{k}} {π}_{n}^{k} ( {x}_{{ni}_{r}}^{k} - {\overline{x}}_{{i}_{r}}^{k} ) ( {x}_{{ni}_{s}}^{k} - {\overline{x}}_{{i}_{s}}^{k} ) - A {\sum }_{k = 1}^{2} {\tilde{π}}^{k} ( {\overline{x}}_{{i}_{r}}^{k} - {q}_{{i}_{r}} ) ( {\overline{x}}_{{i}_{s}}^{k} - {q}_{{i}_{s}} ) ] \\ where \\ γ = \frac{{λ}_{i} {R}^{2}}{{u}_{i}} \qquad ( 27 )$$

Equation (27) can also be written in matrix form as

$${W}_{i}^{- 1} = \frac{1}{γ} {C}_{i} \qquad ( 28 )$$

where Cᵢ is the matrix [cᵢ_{ᵣₛ}] such that

$${c}_{{i}_{rs}} = R {\sum }_{k = 1}^{2} {\sum }_{n = 1}^{{N}_{k}} {π}_{n}^{k} ( {x}_{{ni}_{r}}^{k} - {\overline{x}}_{{i}_{r}}^{k} ) ( {x}_{{ni}_{s}}^{k} - {\overline{x}}_{{i}_{s}}^{k} ) - A {\sum }_{k = 1}^{2} {\tilde{π}}^{k} ( {\overline{x}}_{{i}_{r}}^{k} - {q}_{{i}_{r}} ) ( {\overline{x}}_{{i}_{s}}^{k} - {q}_{{i}_{s}} ) \qquad ( 29 )$$

The value of γ will now be computed independently from λ which is an unknown parameter. Equation (28) can be written as follows:

$${W}_{i}^{- 1} = \frac{1}{γ} {C}_{i} ⇔ {C}_{i} = γ {W}_{i}^{- 1} ⇒ det ( {C}_{i} ) = {γ}^{{H}_{i}} det ( {W}_{i}^{- 1} )$$

but since det(Wᵢ⁻¹)=1, then

$$γ = {( det ( {C}_{i} ) )}^{\frac{1}{{H}_{i}}} {C}_{i}^{- 1} .$$

Finally, the optimal solution for Wᵢ is given by Equation (30)

$${W}_{i} = γ {C}_{i}^{- 1} = {( det ( {C}_{i} ) )}^{\frac{1}{{H}_{i}}} {C}_{i}^{- 1} \qquad ( 30 )$$

where the components of Cᵢ are given by Equation (29).

In the following, the effect of the dispersion of positive and negative examples on the components of Wᵢ will be considered. First, Equation (29) can be rewritten in a matrix form, as follows:
Cᵢ=RCovaᵢ−ACovrᵢ (31)
where Covaᵢ is the sum of intra covariance matrices for the i^{th} feature, i.e., Covaᵢ=[cov aᵢ_{ᵣₛ}] such that
covaᵢ_{ᵣₛ}=Σₖ₌₁²Σₙ₌₁^{N}^{ₖ}πₙ^{k}(xₙᵢ_{ᵣ}^{k}−\overline{x}ᵢ_{ᵣ}^{k})(xₙᵢ_{ₛ}^{k}−\overline{x}ᵢ_{ₛ}^{k})
and Covrᵢ is the inter covariance matrix for the i^{th} feature, i.e., Covrᵢ=[cov rᵢ_{ᵣₛ}] such that
covrᵢ_{ᵣₛ}=Σₖ₌₁²\tilde{π}^{k}(\overline{x}ᵢ_{ᵣ}^{k}−qᵢ_{ᵣ})(\overline{x}ᵢ_{ₛ}^{k}−qᵢ_{ₛ})

Now, considering Equation (31), where the values of “A” and “R” are set since they concern all the features. If the intra dispersion is high relative to the inter dispersion, and hence the elements of Covaᵢ are important relative to the elements of Covrᵢ then, according to Equation (31), the values of the components of Cᵢ will be important. But since Wᵢ=γCᵢ⁻¹ (Equation(30)), it follows that the values of wᵢ_{ᵣₛ} will be small; and consequently, the i^{th} feature's components will be given low weights. On the other hand, if the intra dispersion is low relative to the inter dispersion for the i^{th} feature, by a similar line of reasoning, one can see that this feature's components will be given high weights. This behavior of Wᵢ fulfills the objective of enhancing discriminant features against other ones.

Taking the partial derivative of L with respect to uᵢ allows to obtain the optimal solution for uᵢ.

$$\begin{matrix}\frac{\partial L}{\partial {u}_{i}} = \frac{R \frac{\partial A}{\partial {u}_{i}} - A \frac{\partial R}{\partial {u}_{i}}}{{R}^{2}} + \frac{λ}{{u}_{i}^{2}} \\ where & ( 32 ) \\ \frac{\partial A}{\partial {u}_{i}} = {\sum }_{k = 1}^{2} {\sum }_{n = 1}^{{N}_{k}} {{π}_{n}^{k} ( {\vec{x}}_{ni}^{k} - {\vec{\overline{x}}}_{i}^{k} )}^{T} {W}_{i} ( {\vec{x}}_{ni}^{k} - {{x}^{\vec{\_}}}_{i}^{k} ) \\ and & ( 33 ) \\ \frac{\partial R}{\partial {u}_{i}} = {\sum }_{k = 1}^{2} {{\tilde{π}}^{k} ( {{x}^{\vec{\_}}}_{i}^{k} - {\vec{q}}_{i} )}^{T} {W}_{i} ( {{x}^{\vec{\_}}}_{i}^{k} - {\vec{q}}_{i} ) & ( 34 )\end{matrix}$$

By substituting Equations (33) and (34) in (32), we obtain

$$\frac{\partial L}{\partial {u}_{i}} = 0 ⇔ R [ {\sum }_{k = 1}^{2} {\sum }_{n = 1}^{{N}_{k}} {{π}_{n}^{k} ( {\vec{x}}_{ni}^{k} - {{x}^{\vec{\_}}}_{i}^{k} )}^{T} {W}_{i} ( {\vec{x}}_{ni}^{k} - {{x}^{\vec{\_}}}_{i}^{k} ) ] - A [ {\sum }_{k = 1}^{2} {{\tilde{π}}^{k} ( {{x}^{\vec{\_}}}_{i}^{k} - {\vec{q}}_{i} )}^{T} {W}_{i} ( {\tilde{\overline{x}}}_{i}^{k} - {\vec{q}}_{i} ) ] + \frac{λ {R}^{2}}{{u}_{i}^{2}} = 0 \qquad ( 35 )$$

Both sides of Equation (35) are multiplied by uᵢ, to obtain:

$$\begin{matrix}{u}_{i} {f}_{i} + \frac{λ {R}^{2}}{{u}_{i}} = 0 \\ where & ( 36 ) \\ {f}_{i} = R [ {\sum }_{k = 1}^{2} {\sum }_{n = 1}^{{N}_{k}} {{π}_{n}^{k} ( {\vec{x}}_{ni}^{k} - {{x}^{\vec{\_}}}_{i}^{k} )}^{T} {W}_{i} ( {\vec{x}}_{ni}^{k} - {{x}^{\vec{\_}}}_{i}^{k} ) ] - A [ {\sum }_{k = 1}^{2} {{\tilde{π}}^{k} ( {{x}^{\vec{\_}}}_{i}^{k} - {\vec{q}}_{i} )}^{T} {W}_{i} ( {{x}^{\vec{\_}}}_{i}^{k} - {\vec{q}}_{i} ) ] & ( 37 )\end{matrix}$$

Now, to get rid of the unknown parameter λ, a relation, independent of λ, between uᵢ and any uⱼ is sought. First λ can be computed directly from Equation (36) as follows:

$$λ = - \frac{{f}_{i} {u}_{i}^{2}}{{R}^{2}} ∀ i \qquad ( 38 )$$

Second, taking the sum on i of Equation (36) gives

$${\sum }_{i = 1}^{I} {u}_{j} {f}_{j} + λ {R}^{2} {\sum }_{j = 1}^{I} \frac{1}{{u}_{j}} = 0 ,$$

but since

$${\sum }_{i = 1}^{I} \frac{1}{{u}_{i}} = 1 ,$$

then Σ₌₁^{I}uⱼfⱼ+λR²=0. It follows that

$$λ = \frac{- {\sum }_{i = j}^{I} {u}_{j} {f}_{j}}{{R}^{2}} \qquad ( 39 )$$

Equations (32) and (33) imply that for every feature i

$${f}_{i} {u}_{i}^{2} = {\sum }_{j = 1}^{I} {u}_{j} {f}_{j} \qquad ( 40 )$$

It follows from Equation (40) that f₁u₁²=f₂u₂²= . . . =fᵢuᵢ²=f_{I}u_{I}².

Hence,

$${u}_{j} = {u}_{i} \sqrt{\frac{{f}_{i}}{{f}_{j}}} ∀ j \qquad ( 41 )$$

Finally, to obtain the optimal solution of uᵢ, uⱼ is replaced in Equation (40) by its value from Equation (41), yielding:

$${f}_{i} {u}_{i}^{2} = {\sum }_{j = 1}^{I} ( {u}_{i} \sqrt{\frac{{f}_{i}}{{f}_{j}}} {f}_{j} ) ⇔ {f}_{i} {u}_{i} = {\sum }_{j = 1}^{I} \sqrt{{f}_{i} {f}_{j}} ⇔ {u}_{i} = \frac{{\sum }_{j = 1}^{I} \sqrt{{f}_{j}}}{\sqrt{{f}_{i}}} \qquad ( 42 )$$

The optimal solution for uᵢ is given by Equation (42), where fᵢ is defined by Equation (37).

The influence of the dispersion of positive and negative examples on the value of each uᵢ will now be considered First, fᵢ can be written in Equation (37) as

$$\begin{matrix}{f}_{i} = {RFa}_{i} - {AFr}_{i} \\ where & ( 43 ) \\ {Fa}_{i} = {\sum }_{k = 1}^{2} {\sum }_{n = 1}^{{N}_{k}} {π}_{n}^{k} ( {\vec{x}}_{ni}^{k} - {\vec{\overline{x}}}_{i}^{k} ) {}_{}^{T}{W}{}_{i}^{} ( {\vec{x}}_{ni}^{k} - {\vec{\overline{x}}}_{i}^{k} ) \\ and & ( 44 ) \\ {Fr}_{i} = {\sum }_{k = 1}^{2} {{\tilde{π}}^{k} ( {\vec{\overline{x}}}_{i}^{k} - {\vec{q}}_{i} )}^{T} {W}_{i} ( {\vec{\overline{x}}}_{i}^{k} - {\vec{q}}_{i} ) & ( 45 )\end{matrix}$$

It is assumed that A and R have constant values since they depend on all the features. If, for the i^{th} feature, the intra dispersion is high relative to the inter dispersion, then the quantity Faᵢ will gain in importance relative to the quantity Frᵢ. According to Equation (43), this will increase the value of fᵢ. Moreover, Equation (42) shows that when fᵢ increases, uᵢ decreases; and hence, the i^{th} feature will be given a low weight. Conversely, if, for the i^{th} feature, the intra dispersion is low relative to the inter dispersion, then, by a similar line of reasoning, we find that the i^{th} feature will be given a high weight. Therefore, the optimal value that is found for uᵢ fulfills the objective of enhancing the relevant discriminant features against others.

In brief, the input to step 112 consists of positive example images, negative example images and their respective relevance degrees. A partial result of step 112 includes the optimal parameters Wᵢ and uᵢ. These parameters are computed according to Equations (30) and (42), respectively. The computation of these parameters requires the computation of \overline{\vec{x}}ᵢ¹, \overline{\vec{x}}ᵢ², \overline{q}ᵢ, fᵢ, A and R according to Equations (13), (14), (10), (37), (19) and (20), respectively. The algorithm is iterative since the computation of Wᵢ and uᵢ depends on A and R, and the computation of A and R depends on Wᵢ and uᵢ. The fixed point method is used to perform the computation of Wᵢ and uᵢ. An initialization step is required, in which we adopt the following values:

Wᵢ is initialized with the diagonal matrix

$$( \begin{matrix}\frac{1}{{σ}_{{i}_{1}}} & ⋯ & ⋯ & 0 \\ ⋮ & ⋰ & & ⋮ \\ ⋮ & & ⋰ & ⋮ \\ 0 & ⋯ & ⋯ & \frac{1}{{σ}_{{i}_{{H}_{i}}}}\end{matrix} )$$

$$where$$

$${σ}_{ir} = \sqrt{{\sum }_{k = 1}^{2} {\sum }_{n = 1}^{{N}_{k}} {{π}_{n}^{k} ( {x}_{{ni}_{r}}^{k} - {{q}_{i}}_{r} )}^{2}}$$

is the standard deviation of the r^{th} component of the i^{th} feature computed for the full set of query images.

The parameter uᵢ is initialized with a kind of dispersion given by

$${u}_{i} = \frac{{\sum }_{j = 1}^{I} \sqrt{{f}_{i}}}{\sqrt{{f}_{i}}}$$

$$where$$

$${f}_{i} = \frac{{\sum }_{k = 1}^{2} {\sum }_{n = 1}^{{N}_{k}} {{π}_{n}^{k} ( {\vec{x}}_{ni}^{k} - {\vec{\overline{x}}}_{i}^{k} )}^{T} {W}_{i} ( {\vec{x}}_{ni}^{k} - {\vec{\overline{x}}}_{i}^{k} )}{{\sum }_{k = 1}^{2} {{\tilde{π}}^{k} ( {\vec{\overline{x}}}_{i}^{k} - {\vec{q}}_{i} )}^{T} {W}_{i} ( {\vec{\overline{x}}}_{i}^{k} - {\vec{q}}_{i} )}$$

The computation of Wᵢ requires the inversion of the matrix Cᵢ. However, in the case of (N₁+N₂)<Hᵢ, Cᵢ is not invertible. Ishikawa et al. suggest proceeding by singular value decomposition (SVD) to obtain the pseudo inverse matrix. However, this solution doesn't give a satisfactory result, especially when (N₁+N₂)is far less than Hᵢ as pointed out by Rui et al, who propose, in the case of a singular matrix, to replace Wᵢ by a diagonal matrix whose elements are the inverse of the standard deviation, i.e.,

$${w}_{{i}_{rs}} = \frac{1}{{σ}_{{i}_{s}}}$$

if r=s and w=0 elsewhere.

In step 112, Wᵢ is replaced by a diagonal matrix whose elements are the inverse of the diagonal elements of the matrix Cᵢ, i.e.,

$${W}_{i} = ( \begin{matrix}{{w}_{i}}_{11} & ⋯ & ⋯ & 0 \\ ⋮ & ⋰ & & ⋮ \\ ⋮ & & ⋰ & ⋮ \\ 0 & ⋯ & ⋯ & {w}_{{i}_{{H}_{i} {H}_{i}}}\end{matrix} )$$

where

$${w}_{{i}_{ss}} = \frac{1}{{c}_{{i}_{ss}}}$$

and cᵢ_{ᵣₛ} can be obtained by setting r=s in Equation (26).

In step 114, the relevant images obtained in step 108 are ranked according to a discriminating score based on their closeness to the positive example and their farness from the negative example. The comparison function is given by Equation (44). Finally, the system returns the Nb₂ top-ranked images to the user.

$$D ( {x}_{n} ) = {\sum }_{i = 1}^{I} {{u}_{i} ( {\vec{x}}_{ni} - {\vec{\overline{x}}}_{i}^{1} )}^{T} {W}_{i} ( {\vec{x}}_{ni} - {\vec{\overline{x}}}_{i}^{1} ) - {\sum }_{i = 1}^{I} {{u}_{i} ( {\vec{x}}_{ni} - {\vec{\overline{x}}}_{i}^{2} )}^{T} {W}_{i} ( {\vec{x}}_{ni} - {\vec{\overline{x}}}_{i}^{2} ) \qquad ( 46 )$$

Experimental Results and Performance Evaluation

Tests were performed on 10 000 images from The Pennsylvania State University images database, which is described by J. Li, J. Z. Wang and G. Wiederhold in both “IRM: Integrated region matching for image retrieval.” From the 2000 ACM Multimedia Conference, pages 147-156, San Jose, USA, 2000. and “SIMPLlcity: Semantics-sensitive Integrated Matching for Picture Libraries.” from IEEE Transactions on Pattern Analysis and Machine Intelligence, 23(9):947-963, 2001. This database contains images related to different subjects, emphasizing different features, and taken under different illumination conditions. For each image, the set of features is computed as explained above. Many tests were performed for retrieval and refinement. Even when positive and negative examples are not readily distinguishable, the method according to the present invention succeeded in identifying discrimination features and sorting the resulting images according to these features.

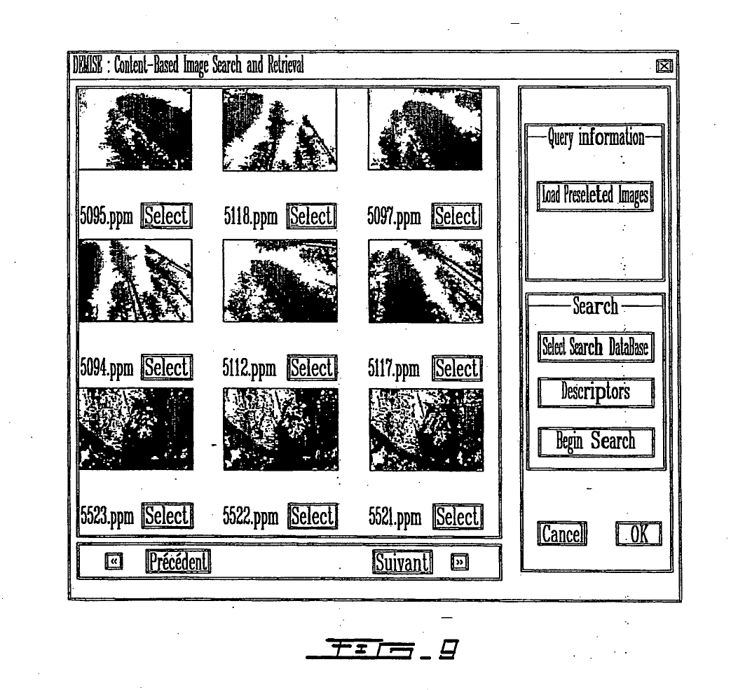

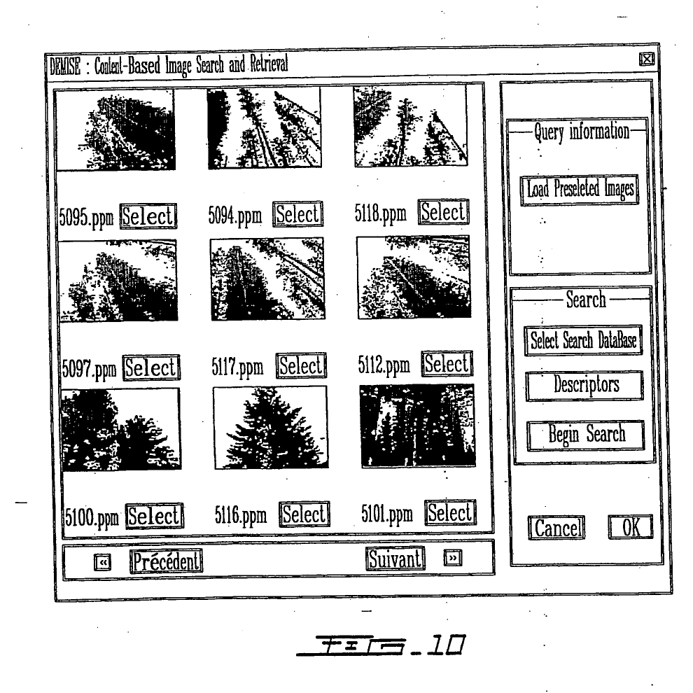

FIG. 9 shows an example of retrieval with positive example only. FIG. 10 shows and example of retrieval with positive and negative examples.

In the first example, two images participated in the query as positive example. Both of these images contain a green tree under the blue sky (5095. ppm and 5118. ppm). FIG. 9 shows the top nine returned images. It is to be noted that the two query images are returned in the top positions. There are also some other images containing trees under the sky, but including noise consisting of three images of a brown bird on a green tree under the blue sky (5523. ppm, 5522. ppm, 5521. ppm). At the same time, there have been miss, because the database contains other images (not shown) of trees under the sky that have not been retrieved.

According to the second example, a refinement has been applied to the results of the first example. Hence, we use the same images (5095. ppm and 5118. ppm) as positive example, while an image of a bird on a tree under the sky is chosen as negative example (image 5521. ppm of FIG. 8). FIG. 9 shows that images of birds are discarded (the noise reduced) and that more images of trees under the sky are retrieved (the miss decreased).

Performance Evaluation

In order to validate the proposed relevance feedback technique, a performance evaluation of a retrieval system implementing a method according to the present invention has been has been performed. The evaluation was based on comparison between the use of positive example only and the use of both positive and negative examples. To perform any evaluation in the context of image retrieval, two main issues emerge: the acquisition of ground truth and the definition of performance criteria. For ground truth, human subjects were used: three persons participated in all the experiences described hereinbelow. The performance criteria, Precision Pr and Recall Re, described by John R. Smith in “Image Retrieval Evaluation.” From the IEEE Workshop on Content-based Access of Image and Video Libraries, 1998 were used.

In their simplest definition, Precision is the proportion of retrieved images that are relevant, i.e., number of retrieved images that are relevant on the number of all retrieved images; and Recall is the proportion of relevant images that are retrieved, i.e., number of relevant images that are retrieved on the number of all relevant images in the database. Smith drew up the precision-recall curve Pr=f(Re); however, it has been observed that this measure is less meaningful in the context of image retrieval since Recall is consistently low. Furthermore, it is believed that it is often difficult to compute Recall, especially when the size of the image database is big; because this requires to know, for each query, the number of relevant images in a the whole database. Another problem with Recall, is that it depends strongly on the choice of the number of images to return to the user. If the number of relevant images in the database is bigger than the number of images returned to the user, then the recall will be penalized. A more expressive curve which is the precision-scope curve Pr=f(Sc), as described by Huang et al, “Image Indexing using Color Correlogram.” From the IEEE Conference on Computer Vision and Pattern Recognition, 1997, has been used. Scope Sc is the number of images returned to the user, and hence the curve Pr=f(Sc) depicts the precision for different values of the number of images returned to the user. Since these performance criteria are believed to be well known in the art, they will not be described herein in further detail.

Two experiences were carried out, each of which aiming to measure a given aspect of our model. The first experience aims to measure the improvement, with negative example, in the relevance of retrieved images. The second experience aims to measure the improvement, with negative example, in the number of iterations needed to locate a given category of images.

First Experience

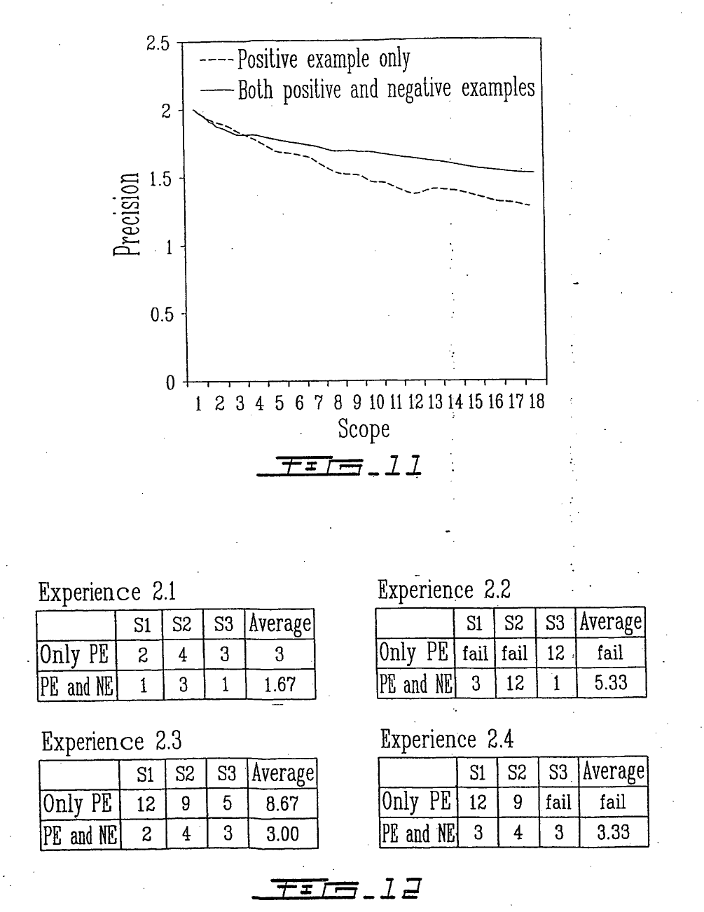

As mentioned above, the goal of the first experience is to measure the contribution of negative example in the improvement of the relevance of retrieved images. Each human subject participating in the experience was asked to formulate a query using only positive example and to give a goodness score to each retrieved image, then to refine the results using negative example and to give a goodness score to each retrieved image. The possible scores are 2 if the image is good, 1 if the image is acceptable, and 0 if the image is bad. Each subject repeated the experience five times by specifying a new query each time. Precision was computed as follows: Pr=the sum of degrees of relevance for retrieved images/the number of retrieved images. FIG. 11 illustrates a comparison between the curves Pr=f(Sc) in the two cases: retrieval with positive example and refinement with negative example.

The experiences shows that, in average, when negative example is introduced, the improvement in precision is about 20%. In fact, the improvement varies from one query to another, because it depends on other factors such as the choice of a meaningful negative example and the constitution of the database. If, for a given query, the database contains a little number of relevant images, most of which have been retrieved in the first step, then the introduction of negative example or any other technique will not be able to bring any notable improvement.

Second Experience

The second experience aims at measuring the improvement in the number of refinement iterations needed to locate a given category of images, as well as the role of negative example in resolving the page zero problem (finding a good image to initiate the retrieval). Each of our human subjects was shown a set of images that are relatively similar to each other with respect to the color. None of the showed images appear in the set of images the subjects can use to formulate the initial query. Each subject is asked to locate at least one of the showed images using only positive example, and to count the number of iterations; then to restart the experience but using both positive and negative examples, and to count the number of iterations. This experience was repeated four times and the results are given in FIG. 12. S1, S2 and S3 designate respectively the three human subjects who participated in the experiments. PE means positive example and NE means negative example. Each entry in the table gives the number of iterations needed to locate the searched images.

It has been found that when they used both positive and negative examples, the subjects succeeded in all the experiences; however, when they used only positive example, some of them failed in certain experiences to locate any sought image. In Experience 2.2 and Experience 2.4, at least one subject was unable to locate any sought image using positive example only. This is because, in a given iteration, all the retrieved images fall into an undesired category, and the formulation of the next-iteration query using any of these images leads to retrieve images belonging to the same category. The user can loop indefinitely, but will not be able to escape this situation by using positive example only. The second observation is that the use of negative example reduces appreciably the number of iterations. If one computes the average number of iterations among the successful experiences (2.1 and 2.3), one finds 5.83 when only positive example is used, and 2.33 when both positive and negative examples are used. This experience shows clearly the role of negative example in mitigating the page zero problem. Indeed, after having obtaining at least one of the sought images, the user can use it to formulate a new query, and hence to retrieve more sought images.

A content-based image retrieval method according to the present invention allows to take into account the user's needs and specificities, which can be identified via relevance feedback. It has been shown that the use of positive example only isn't always sufficient to determine what the user is looking for. This can be seen especially when all the candidate images to participate in the query appear in an inappropriate context or contain, in addition to the features the user is looking for, features or objects that the user doesn't want to retrieve.

It is to be noted that the present model is not limited to image retrieval but can be adapted and applied to any retrieval process with relevance feedback. For example, a method according to the present invention can be used any process of retrieval such as retrieval of text, sound, and multimedia.

Although the present invention has been described hereinabove by way of preferred embodiments thereof, it can be modified, without departing from the spirit and nature of the subject invention.

What is claimed is:

1. A content-based method for retrieving data files among a set of database files comprising:
providing positive and negative examples of data files; said positive example including at least one relevant feature;
providing at least one discriminating feature in at least one of said positive and negative examples allowing to differentiate between said positive and negative examples;
for each database file in said set of database files, computing a relevance score based on a similarity of said each database file to said positive example considering said at least one relevant feature;
creating a list of relevant files comprising the Nb₁ files having the highest similarity score among said set of database files; Nb₁ being a predetermined number;
for each relevant file in said list of relevant files, computing a discrimination score based on a similarity of said each relevant file to said positive example considering said at least one discriminating feature and on a dissimilarity of said each relevant file to said negative example considering said at least one discriminating feature; and
selecting the Nb₂ files having the highest discrimination score among said list of relevant files; Nb₂ being a predetermined number.

2. A content-based method for retrieving images among a set of database images comprising:
providing positive and negative example images; said positive example image including at least one relevant feature;
providing at least one discriminating feature in at least one of said positive and negative examples allowing to differentiate between said positive and negative example images;
for each database image in said set of database images, computing a relevance score based on a similarity of said each database image to said positive example image considering said at least one relevant feature;
creating a list of relevant images comprising the Nb₁ images having the highest relevance score among said set of database images; Nb₁ being a predetermined number;
for each relevant image in said list of relevant images, computing a discrimination score based on a similarity of said each relevant image to said positive example image considering said at least one discriminating feature and on a dissimilarity of said each relevant image to said negative example image considering said at least one discriminating feature; and
selecting the Nb₂ images having the highest discrimination score among said list of relevant images; Nb₂ being a predetermined number.

3. A method as recited in claim 2, wherein said at least one of said positive and negative examples being the weighted average of a plurality of images.

4. A method as recited in claim 2, wherein said at least one relevant feature includes a number I of relevant features.

5. A method as recited in claim 4, wherein said positive example image being the weighted average \overline{\vec{x}}ᵢ¹ of N₁ positive examples for each relevant feature I.

6. A method as recited in claim 5, wherein \overline{\vec{x}}ᵢ¹ is defined by:
$${\vec{\overline{x}}}_{i}^{1} = \frac{{\sum }_{n = 1}^{{N}_{1}} {π}_{n}^{1} {x}_{ni}^{1}}{{\sum }_{n = 1}^{{N}_{1}} {π}_{n}^{1}}$$
wherein πₙ¹ is a relevance degree for the positive example n.

7. A method as recited in claim 6, wherein said at least one discriminating feature includes a number I of discriminating features; said negative example image being the weighted average \overline{\vec{x}}ᵢ² of N₂ negative examples for each relevant feature i; \overline{\vec{x}}ᵢ² being defined by:
$${\vec{\overline{x}}}_{i}^{2} = \frac{{\sum }_{n = 1}^{{N}_{2}} {π}_{n}^{2} {x}_{ni}^{2}}{{\sum }_{n = 1}^{{N}_{2}} {π}_{n}^{2}}$$
wherein πₙ² is a relevance degree for the negative example n.

8. A method as recited in claim 7, wherein \tilde{π}¹+\tilde{π}²=1 where: \tilde{π}¹=Σₙ₌₁^{N}^{₁}πₙ¹ and \tilde{π}²=Σₙ₌₁^{N}^{₂}πₙ².

9. A method as recited in claim 8, wherein \tilde{π}₁=0.5 and \tilde{π}₂=0.5.

10. A method as recited in claim 2, wherein each of the set of database images and of the positive and negative example images is represented by a set of image features.

11. A method as recited in claim 3, wherein each of said set of image features being represented by a feature vector.

12. A method as recited in claim 11, wherein computing a relevance score includes computing the distance between said positive example image and said each database image; said highest relevance score corresponding to the lowest of said distance between said positive example image and said each database image.

13. A method as recited in claim 12, wherein said at least one relevant feature includes a number I of relevant features; said positive example image is the weighted average \overline{\vec{x}}ᵢ¹ of N₁ positive examples for each relevant feature i; \overline{\vec{x}}ᵢ¹ being defined by:
$${\vec{\overline{x}}}_{i}^{1} = \frac{{\sum }_{n = 1}^{{N}_{1}} {π}_{n}^{1} {x}_{ni}^{1}}{{\sum }_{n = 1}^{{N}_{1}} {π}_{n}^{1}}$$
wherein πₙ¹ is a relevance degree for the positive example n;
said distance between said positive example image and said each database image represented by feature vector \overline{\vec{x}}ₙᵢ being defined by:
$$D ( {x}_{n} ) = {\sum }_{i = 1}^{I} {{u}_{i} ( {\vec{x}}_{ni} - {\vec{\overline{x}}}_{i}^{1} )}^{T} {W}_{i} ( {\vec{x}}_{ni} - {\vec{\overline{x}}}_{i}^{1} )$$
wherein uᵢ is the global weight assigned to the i^{th} relevant feature; and
Wᵢ is a symmetric matrix that allows defining the generalized ellipsoid distance D and weighting components of each of said at least one relevant feature; and uᵢ and Wᵢ minimizing the dispersion Jₚₒₛᵢₜᵢᵥₑ of positive example images
$${J}_{positive} = {\sum }_{i = 1}^{I} {u}_{i} {\sum }_{n = 1}^{{N}_{1}} {{π}_{n}^{1} ( {\vec{x}}_{ni}^{1} - {\vec{\overline{x}}}_{i}^{1} )}^{T} {W}_{i} ( {\vec{x}}_{ni}^{1} - {\vec{\overline{x}}}_{i}^{1} )$$

14. A method as recited in claim 12, wherein computing a discrimination score includes computing the distance between said negative example image and said each database image; said highest discrimination score corresponding to the lowest of said distance between said negative example image and said each database image.

15. A method as recited in claim 14, wherein said at least one relevant feature includes a number I of relevant features; said positive example image is the weighted average \overline{\vec{x}}ᵢ¹ of N₁ positive examples for each relevant feature i; \overline{\vec{x}}ᵢ¹ being defined by:
$${\vec{\overline{x}}}_{i}^{1} = \frac{{\sum }_{n = 1}^{{N}_{1}} {π}_{n}^{1} {x}_{ni}^{1}}{{\sum }_{n = 1}^{{N}_{1}} {π}_{n}^{1}}$$
wherein πₙ¹ is a relevance degree for the positive example n;
said negative example image is the weighted average \overline{\vec{x}}ᵢ² of N₂ negative examples for each relevant feature i; \overline{\vec{x}}ᵢ² being defined by:
$${\vec{\overline{x}}}_{i}^{2} = \frac{{\sum }_{n = 1}^{{N}_{2}} {π}_{n}^{2} {x}_{ni}^{2}}{{\sum }_{n = 1}^{{N}_{2}} {π}_{n}^{2}}$$
wherein πₙ² is a relevance degree for the negative example n;
said distance between said positive example image and said each database image represented by feature vector \overline{\vec{x}}ₙᵢ minus said distance between said negative example image and said each database image represented by feature vector \overline{\vec{x}}ₙᵢ being defined by:
$$D ( {x}_{n} ) = {\sum }_{i = 1}^{I} {{u}_{i} ( {\vec{x}}_{ni} - {\vec{\overline{x}}}_{i}^{1} )}^{T} {W}_{i} ( {\vec{x}}_{ni} - {\vec{\overline{x}}}_{i}^{1} ) - {\sum }_{i = 1}^{I} {{u}_{i} ( {\vec{x}}_{ni} - {\vec{\overline{x}}}_{i}^{2} )}^{T} {W}_{i} ( {\vec{x}}_{ni} - {\vec{\overline{x}}}_{i}^{2} )$$
wherein uᵢ is the global weight assigned to the i^{th} relevant feature; and
Wᵢ is a symmetric matrix that allows to define the generalized ellipsoid distance D; and uᵢ and Wᵢ minimizing the internal dispersion of positive example images, minimizing the internal dispersion of the negative example images, and maximizing the discrimination between the positive and the negative examples.

16. A method as recited in claim 15, wherein minimizing the internal dispersion of positive example images, minimizing the internal dispersion of the negative example images, and maximizing the discrimination between the positive and the negative examples is achieved by minimizing A/R where:
$$A = {\sum }_{i = 1}^{I} {u}_{i} {\sum }_{k = 1}^{2} {\sum }_{n = 1}^{{N}_{k}} {{π}_{n}^{k} ( {\vec{x}}_{ni}^{k} - {\vec{\overline{x}}}_{i}^{k} )}^{T} {W}_{i} ( {\vec{x}}_{ni}^{k} - {\vec{\overline{x}}}_{i}^{k} )$$
$$R = {\sum }_{i = 1}^{I} {u}_{i} {\sum }_{k = 1}^{2} {{\tilde{π}}^{k} ( {\vec{\overline{x}}}_{i}^{k} - {\vec{q}}_{i} )}^{T} {W}_{i} ( {\vec{\overline{x}}}_{i}^{k} - {\vec{q}}_{i} )$$
where k=1 for positive example and k=2 for negative example, and where \overline{q}ᵢ is the weighted average of all positive and negative example images for the i^{th} feature and is defined by
$${\vec{q}}_{i} = \frac{{\sum }_{k = 1}^{2} {\sum }_{n = 1}^{{N}_{k}} {π}_{n}^{k} {\vec{x}}_{ni}^{k}}{{\sum }_{k = 1}^{2} {\sum }_{n = 1}^{{N}_{k}} {π}_{n}^{k}}$$

17. A method as recited in claim 2, wherein said positive and negative example images are selected by a person among a list of sample images.

18. A content-based method for retrieving data files among a set of database files, the method comprising:
providing positive and negative example of data files; said positive example image including at least one relevant feature;
restricting the set of database files to a subset of files selected among said database files; each files in said subset of files being selected according to its similarity with said positive example based on said at least one relevant feature;
retrieving files in said subset of files according to their similarity with said positive example based on said at least one relevant feature and according to their dissimilarity with said negative example based on at least one discriminating feature between said positive and negative examples; whereby, the files retrieved among said database files corresponding to files similar to said positive example and dissimilar to said negative example.

19. A content-based method for retrieving images among a set of database images, the method comprising:
providing positive and negative example images; said positive example image including at least one relevant feature;
restricting the set of database images to a subset of images selected among said database images; each images in said subset of images being selected according to its similarity with said positive example based on said at least one relevant feature;
retrieving images in said subset of images according to their similarity with said positive example based on said at least one relevant feature and according to their dissimilarity with said negative example based on at least one discriminating feature between said positive and negative examples; whereby, the images retrieved among said database images corresponding to images similar to said positive example and dissimilar to said negative example.

20. A content-based system for retrieving images among a set of database images comprising: means for providing positive and negative example images; said positive example image including at least one relevant feature;
means for providing at least one discriminating feature in at least one of said positive and negative examples allowing to differentiate between said positive and negative example images;
means for computing, for each database image in said set of database images, a relevance score based on a similarity of said each database image to said positive example image considering said at least one relevant feature;
means for creating a list of relevant images comprising the Nb₁ images having the highest similarity score among said set of database images; Nb₁ being a predetermined number;
means for computing, for each relevant image in said list of relevant images, a discrimination score based on a similarity of said each relevant image to said positive example image considering said at least one discriminating feature and on a dissimilarity of said each relevant image to said negative example image considering said at least one discriminating feature; and
means for selecting the Nb₂ images having the highest discrimination score among said list of relevant images; Nb₂ being a predetermined number.

21. A system as recited in claim 20, wherein said means for providing positive and negative example images includes a graphical user interface displaying sample images.

22. A system as recited in claim 20, wherein said graphical user interface includes means for specifying the degree of relevance of each said sample images.

23. A system as recited in claim 22, wherein said graphical user interface includes means for viewing the retrieved images.

24. An apparatus for retrieving images among a set of database images, the apparatus comprising:
an interface adapted to receive positive and negative example images; said positive example image including at least one relevant feature;
a restriction component operable to restrict the set of database images to a subset of images selected among said database images; said images in said subset of images being selected according to their similarity with said positive example based on said at least one relevant feature;
a retrieval component operable to retrieve images in said subset of images according to their similarity with said positive example based on said at least one relevant feature and according to their dissimilarity with said negative example based on at least one discriminating feature between said positive and negative examples;
whereby, the images retrieved among said database images correspond to images similar to said positive example and dissimilar to said negative example.

25. An apparatus according to claim 24, wherein the restriction component and the retrieval component are implemented within the same logic device.

26. A computer readable memory comprising content-based image retrieval logic for retrieving images among a set of database images, the content-based image retrieval logic comprising:
image reception logic operable to receive positive and negative example images; said positive example image including at least one relevant feature;
restriction logic operable to restrict the set of database images to a subset of images selected among said database images; said images in said subset of images being selected according to their similarity with said positive example based on said at least one relevant feature; and
retrieval logic operable to retrieve images in said subset of images according to their similarity with said positive example based on said at least one relevant feature and according to their dissimilarity with said negative example based on at least one discriminating feature between said positive and negative examples;
whereby, the images retrieved among said database images correspond to images similar to said positive example and dissimilar to said negative example.
